(19) United States
(12) Patent Application Publication
(10) Pub. No.: US 2015/0114372 A1
(43) Pub. Date: Apr. 30, 2015

(54) Structures, functions, and methods regarding internal combustion engines

(71) Applicant: Matthew Cobb, Dallas, TX (US)

(72) Inventor: Matthew Cobb, Dallas, TX (US)

(21) Appl. No.: 14/531,144

(22) Filed: Nov. 3, 2014

Related U.S. Application Data
(63) Continuation of application No. PCT/US2013/039225, filed on May 2, 2013.

(51) Int. Cl. F02B 75/02; F01N 13/10; F02B 29/02; F02B 1/12

(52) U.S. Cl. CPC F02B 75/02; F02B 1/12; F01N 13/10; F02B 29/02; F02B 2075/025
USPC 123/65 EM

(57) ABSTRACT

Improved structures, functions, and methods regarding internal combustion engines (ICE's). ICE embodiments disclosed are divided into three groups, all of which have at least one embodiment structurally possessing at least one actively powered fan cooperating with at least one exhaust manifold. All of said embodiments disclosed at least solve the objective technical problem of reducing emissions in an ICE. Said embodiments include both normally aspirated and forced induction ICE's. Said embodiments are capable of operation in two stroke cycle Homogeneous Charge Compression Ignition (HCCI) mode, two stroke cycle spark ignition mode, two stroke cycle combination spark ignition and HCCI mode, or four stroke cycle spark ignition mode. The technical field respecting all embodiments and or their methodologies relates generally to ICE's. Principal uses of the embodiments include enabling the operation of ICE's in the above said various mode or modes.

### NOTICE OF PRIORITY

Notice: This application is a continuation of International Application No. PCT/US2013/39225, filed on 2 May, 2013. Said PCT filing claims priority to US Provisional Patent Application No. 61/641,335, filed on 2 May, 2012. As of the date of this filing, there was no International Search Report nor Written Opinion of the ISA issued in regards to the above said PCT Application.

### GENERAL STATEMENT OF UTILITY/INDUSTRIAL APPLICABILITY

All structural embodiments and the methods relating thereto which are disclosed herein relate to Internal Combustion Engines (ICE's). Said ICE's are useful in industrial processes requiring motive power, and in the transportation sector for use in motor vehicles.

### GENERAL TECHNICAL FIELD

The technical field respecting all structural embodiments and the methods relating thereto which are disclosed herein relates generally to Internal Combustion Engines (ICE's), and, specifically, to their structures, functions, and or methodologies of construction and or use.

### GENERAL OBSERVATIONS AND NOTES REGARDING THIS APPLICATION

### Organizational Structure of this Application

This application is organized pursuant to the so called “Problem and Solution Approach” (“PSA”), and is organized into three Groups, “A”, “B”, and “C”, which Groups are addressed seriatim herein. Under said PSA, an Objective Technical Problem (“OTP”) which is to be solved by the structures, functions, and or methodologies disclosed herein must be divined from the closest prior art as to each Group. The several solutions to said OTP's must each involve an Inventive Step and also be Un-obvious. Therefore, the closest prior art which was utilized by Applicant to so frame each OTP is reviewed below. Since the below framed OTP's respecting Groups “A”, “B”, and “C” go to the heart of the said Group's embodiment particulars as disclosed herein, and since each said OTP must be and was framed within the context of each of Group's “A”, “B”, and “C” closest prior art, said prior art review(s) are indeed a basic part of the Specification herein, and, as such, are set forth in the “Best Mode and Detailed Description, Part I—” sections of each Grouping, as below.

In a further effort to organize this application so that it may best enable one skilled in the art to make and use all embodiments disclosed herein and the equivalents thereof, said application has the following headings for each Group:
Group Sub-Title.
Group Introduction.
Group Brief Description of the Drawings.
Part I—Group Best Mode and Detailed Description.
   Overview of Group disclosed embodiment(s)' common limitations.
   Preview of the OTP solved by all Group embodiments.
   Group Advantages and or Alternatives as compared to the Prior Art.
   Preview of Inventive Step generally pertaining to all Group embodiments.
   The closest prior art pertaining to all Group Embodiments.
   Group ICE Primary Structural Configuration and Theory of Operation of Disclosed Embodiment Group.
   Non-obviousness of said Group Inventive Step.
Part II—Group Best Mode and Detailed Description.
   Explanation of Disclosed Embodiments.
After each of Groups A, B, and C are presented in the above format, all Claims pertaining to all embodiments disclosed herein are presented in one “Claims” section.
Note as to FIGURES—

As to all of the below detailed embodiment FIGURES, their main purpose is to show disclosed embodiments in accord with the structures, functions, methodologies, and principals respecting the several Groups “A”, “B”, and “C” herein. Items shown in said FIGURES such as: intake ports, intake manifold, optional intake throttle, exhaust manifold(s), exhaust ports, actively powered exhaust fan(s), first exhaust manifold, second exhaust manifold, engine parameter sensor, optional exhaust throttle, sensor signal controller, controller, connections, exhaust turbine, cylinder head, mechanical exhaust fan drive, electrical generator, valve(s), piston(s), crankshaft, connecting rod, optional spark plug (if engine is SI), fuel injector(s), intake air compressor, check valve, cylinder, optional intake air intercooler (not shown) position, left crankshaft, right crankshaft, electrical motor, and electrical motor/generator are so positioned in said FIGURES for reader understanding and clarity, and said positions of said elements may be moved or adjusted in accordance with the principals disclosed herein as the case requires.

### Note as to Prior Art

Each of Groups A, B, and C have their own Prior Art sections, wherein the closest prior art is reviewed. Because, generally, this application deals with combustion technology of the Internal Combustion Engine (ICE), there may be overlap between the several Group's prior art disclosed herein. By organizing said Groups herein in the fashion presented, Applicant does not mean to infer that the closest prior art pertaining to one Group is necessarily irrelevant to any of the other Groups, and the reader hereof should not assume otherwise.

Definition 1—the term “normally aspirated” herein in connection with an ICE means that its intake air is brought in via suction, and said term includes (non-turbocharged and non-supercharged) four stroke cycle, and so called “crankcase scavenged” two stroke cycle, ICE's. Such definition is consistent with the book “Automotive Engines”, by S. Srinivasan, published by Tata McGraw Hill, 2001, 5th Reprint, 2007 at Chapter 2, Section 2.6.1. In case of conflict between said definitions, this definition governs.

Definition 2—the term “scavenging” herein means the replacement of in all or in part, the residual exhaust products in an Internal Combustion Engine (ICE) with fresh charge.

### UNITY OF INVENTION

Please note that, apart from the Abstract herein, the following paragraphs under this heading of Unity of Invention comprise the only text in this document which was not part of Applicant's U.S. Provisional Patent Application to which this PCT Application relates. Said text add no substance to the Description herein whatsoever. Rather, it summarizes why Unity of Invention exists respecting the Claims set forth herein. There are three groupings (“A”, “B”, and “C”) of embodiments, as more fully described herein. GROUP “A” is sub-Titled “Reduced NOx emissions Internal Combustion Engine (ICE) embodiments”, and the OTP which said embodiments solve is “the reduction of at least NOx emissions from a two stroke cycle ICE”. GROUP “B” is sub-Titled “Reduced CO2 emissions enlarged expansion ratio Internal Combustion Engine embodiments”, and the OTP which said embodiments solve is “the reduction of CO2 emissions (i.e, increased fuel economy) as pertains to a normally aspirated ICE by increasing its actual or its effective so called expansion ratio, without incurring the loss of power normally associated with the so called “Atkinson Cycle” which is so employed in the prior art to increase said expansion ratio”. GROUP “C” solves two Objective Technical Problems (OTP's) which are: (i) increasing ICE fuel efficiency (i.e., reducing CO2 emissions) by utilizing a turbine to capture exhaust gas energy otherwise wasted, whilst (ii) minimizing the turbine(s)' consequent negative impact on various ICE performance characteristics, including decreased engine responsiveness such as so called “turbo lag”. It may be argued that the last mentioned two-part OTP is in reality but one OTP, namely, optimizing the balancing act between (i) and (ii).

Given the above summarized groups of embodiments, Unity of Invention here exists because: (1) every single embodiment described and claimed herein solves at least one common OTP, namely, emissions reduction in an ICE; (2) at least one claimed embodiment belonging to each embodiment group structurally includes at least one actively powered fan cooperating with at least one exhaust manifold in a novel and unobvious way, and same therefore constitutes a special technical feature common to all of said embodiment groups claimed herein; and (3) the novel and unobvious utilization of such fans to scavenge or assist in scavenging at least one claimed embodiment belonging to each embodiment group further constitutes a single general inventive concept common to all claim groups.

### GROUP “A”

### Group “A” Sub-Title-Reduced NOx Emissions Internal Combustion Engine (ICE) Embodiments

### Group “A” Introduction

All Group “A” embodiments disclosed herein possess at least the following common features which distinguish them from the prior art: Normally aspirated, two stroke cycle, ICE's, without crankcase to cylinder transfer port(s), said ICE's comprised of at least one piston, at least one cylinder, at least one combustion chamber, at least one intake and at least one exhaust passage to said at least one combustion chamber, and at least one actively powered fan in, or otherwise cooperating with, at least one exhaust manifold, said ICE further structured to have said at least one intake passage and said at least one exhaust passage both open at at least one apparatus position.

Generally, the prior art of two stroke cycle ICE's has utilized several structures and or methodologies which attempt to retain, or which otherwise attempt to place, a controlled amount of inert residual exhaust gas combustion product from one engine cycle for combining with incoming fresh air charge (and fuel) for use in the next engine cycle. If properly managed, the foregoing may permit a substantial reduction in at least NOx emissions otherwise produced by said two stroke cycle engine. Soot and unburned Hydrocarbon (HC) emissions are controlled by ensuring the homogeneity of the fuel air charge so that it may burn evenly and fully. As seen in the below detailed review of the closest prior art, said prior art structures and or methodologies have included so called exhaust gas recirculation (EGR) and or various physical ways to “trap” hot combustion products whilst they are still present within the ICE combustion chamber. In either scenario, a portion of said combustion products are sought to be mixed with incoming fresh air charge for use in the engine's next operating cycle. Specifically, both two stroke cycle (“2S”) Homogeneous Charge Compression Ignition (“HCCI”) ICE's and two stroke cycle (“2S”) Spark Ignition (“SI”) ICE's have sought to trap varying amounts of inert residual exhaust gasses from one engine cycle to the next. This is because the reduction of fresh intake air (containing high percentages of both Oxygen and Nitrogen) which is brought about by its partial substitution with effectively inert exhaust gasses, substantially reduces NOx emissions owing to the fact that the temperature of combustion is thereby lowered below the point where significant Oxides of Nitrogen are produced. Details on the operation and theory of said HCCI Engines may be found in the several below described Patents and Published Applications, and this application otherwise assumes that the reader thereof is familiar with said operation and theory.

Note that a homogeneous air fuel mixture should be provided for those 2S HCCI Mode engine embodiments disclosed herein and their equivalents. This may be facilitated in the standard ways by utilizing port fuel injection, by in-cylinder (i.e., Direct) fuel injection, by carburetor, or by any of their equivalents. As to the above mentioned 2S SI Mode engines disclosed herein, they may be run in different fuel-air modes, including homogeneous charge mode, or stratified charge mode, or some combination thereof. Said stratified charge mode may be accomplished by utilizing in cylinder Direct Fuel Injection.

Because of their common need to incorporate varying amounts of residual exhaust gasses into their intake charges in order to meaningfully reduce NOx emissions, both 2S S I and 2S HCCI ICE embodiments disclosed herein may optionally share structure, function, and or methodologies. See Detailed Description and Best Mode section herein. That said, combining the two (SI plus HCCI) modes into one hybrid mode engine, wherein the HCCI mode may operate very economically over the low to mid ranges (when power demand is modest), and the SI may operate from the mid range to high range (when more power is demanded), becomes feasible. Given the above, certain disclosed embodiments under this ICE Primary Structural Configuration Group “A” may operate in pure HCCI mode. Certain disclosed embodiments so disclosed may operate in pure SI mode. Lastly, certain embodiments so disclosed may operate in a mixed (hybrid) mode comprising both SI and HCCI. See Claims herein. By this paragraph, Applicant in no way disparages the use of an HCCI ICE as disclosed herein for full power applications, nor does Applicant disparage the use of an SI ICE for low power application, including idle.

### Group “A” Brief Description of the Figures

FIG. 1—Partial view of a two stroke cycle normally aspirated ICE, without any crankcase to cylinder transfer ports, showing a uniflow design, with arrows indicating flow direction, shown comprised of intake manifold 3, optional intake throttle 6, exhaust manifold 7, exhaust port 8, actively powered exhaust fan 9, engine parameter sensor 13, optional exhaust throttle 14, intake valves 25, piston 27, crankshaft 29, connecting rod 31, optional spark plug 33, fuel injector 35, and cylinder 41.

FIG. 3—conceptual view of normally aspirated generic two stroke cycle ICE 5, with arrows 1 indicating flow direction, shown comprised of ICE intake manifold 3, exhaust manifold 7, exhaust fan 9, optional engine parameter sensor 13, optional exhaust throttle 14, sensor signal controller 15, controller(s) 17, and connections 19.

FIG. 5—conceptual view of normally aspirated opposed piston two stroke cycle uniflow ICE with arrows indicating flow direction, shown comprised of intake port 2, intake manifold 3, optional intake throttle 6, exhaust manifold 7, exhaust port 8, actively powered exhaust fan 9, engine parameter sensor 13, optional exhaust throttle 14, pistons 27, connecting rod 31, optional spark plug 33, fuel injector 35, cylinder 41, left crankshaft 49, and right crankshaft 51.

### Part I—Group “A” Best Mode and Detailed Description

### Overview of Group “A” Disclosed Embodiment(s)' Common Limitations

All Group “A” embodiments disclosed herein possess at least the following common structural features which distinguish them from the prior art:

Normally aspirated, two stroke cycle, ICE's, without crankcase to cylinder transfer port(s), said ICE's comprised of at least one piston, at least one cylinder, at least one combustion chamber, at least one intake and at least one exhaust passage to said at least one combustion chamber, and at least one actively powered fan in, or otherwise cooperating with, at least one exhaust manifold, said ICE further structured to have said at least one intake passage and said at least one exhaust passage both open at at least one apparatus position.

### Preview of the OTP Solved by all Group “A” Embodiments

The reduction of at least NOx emissions from a two stroke cycle ICE. Said objective technical problem (OTP) was formulated by and through distinguishing the common features of all Group “A” embodiments disclosed herein from those features pertaining to the closest prior art (also disclosed herein). Said OTP is well recognized in the prior art and or is otherwise capable of being deduced therefrom by a person skilled in the art of automotive engineering.

### Group “A” Advantages and or Alternatives as Compared to the Prior Art

Regarding two stroke cycle ICE's of the prior art, it is often desirous to have a certain proportion of spent residual exhaust gas (from the prior engine cycle) mixed with incoming fresh air charge to reduce the oxygen content of the composite mixture. This in turn reduces the resulting combustion temperature of the next combustion event, which leads to a reduction in at least NOx emissions. To so achieve said at least NOx emission reductions, the prior art of two stroke cycle ICE's teaches forced induction or crankcase scavenging, in combination with exhaust gas recirculation (EGR) and or in combination with physically “trapping” residual exhaust gasses via exhaust restrictions, to control said two stroke cycle ICE's fresh air/residual exhaust gas composite mixture proportions.

Apart from the above described common structural features which distinguish all Group “A” embodiments disclosed herein from the prior art, each of said Group “A” embodiments constitutes an alternative to, and or a technical improvement over, the prior art, and each possesses the following inventive functional and or methodological features which further distinguishes them from the prior art:

Scavenging a normally aspirated two stroke cycle ICE containing no transfer ports, whilst also retaining within said ICE a desired amount of residual (inert) exhaust gas from cycle to cycle, by and through regulation of the above mentioned at least one exhaust manifold's at least one actively powered fan's gas flow rate vis a vis said ICE's gas flow rate during a period of positive intake and exhaust passage overlap.

### Preview of Inventive Step Generally Pertaining to all Group “A” Embodiments

Scavenging a normally aspirated two stroke cycle ICE containing no transfer ports, whilst also retaining within said ICE a desired amount of residual (inert) exhaust gas from cycle to cycle for the purpose of at least NOx emissions reduction, by regulation of said at least one exhaust fan's effective flow rate, said scavenging to occur at least during a period of intake and exhaust passage positive overlap. As seen herein, said regulation may be also be accomplished and or augmented by the use of an exhaust throttle, and or by the use of an intake throttle.

### Rationale in Part for Inventive Step

Vacuuming exhaust gasses from an exhaust passage of a normally aspirated two stroke cycle ICE combustion chamber at least during a period of intake and exhaust passage positive overlap, which said chamber is free of gas disturbances caused by forced induction and or crankcase scavenging techniques of the prior art, provides superior controllability over the amount of residual exhaust gasses sought to be removed. Prior art two stroke cycle ICE's which attempt to displace with pressurized (intake) fresh air a desired portion/percentage of said exhaust gasses out of the combustion chamber promote turbulence, the consequent mixing of said fresh charge with said residuals, and or promote short circuiting of fresh air through said residuals, which, separately or together, serve to reduce control over the precise amount of said residual exhaust gasses sought to be removed.

Even if a prior art structure, function, and or methodology relating to EGR and or “trapping” of residual exhaust gasses in two stroke cycle ICE's could solve the above stated OTP, the inventive step herein nonetheless still constitutes an alternative structure, function, and or methodology to solve said OTP. In no way does this application seek to disclaim, criticize, disparage, or discredit the use of EGR and or “trapping” as above.

### The Closest Prior Art Pertaining to all Group “A” Embodiments

We first examine the underpinnings of the OTP solved by said Group “A” disclosed embodiments by a review of the closest references pertaining to two stroke cycle ICE's which seek to retain a quantity of exhaust gas residuals for the purpose of emissions reduction. The following patents and or patent applications were consulted for this discussion, and provide ample evidence that the Objective Technical Problem articulated herein as to Group “A” is well known in the prior art, said prior art fashioning different (below discussed) solutions to said OTP, none of which teach, suggest, or motivate vis a vis the solution described herein to the same OTP.

Lotus Cars Limited (Assignee), US 20100300411 A 1, Publication date Dec. 2, 2010, titled: “Two Stroke Internal Combustion Engine with Variable Compression Ratio and Exhaust Port Shutter”. The “Omnivore” Research Engine therein described adopts a so called shutter valve to retain a desired amount of exhaust gas residuals in a two stroke cycle ICE operating in either HCCI and or SI modes. While not disclosed in its 411 application or in official Lotus Publications, said Omnivore engine appears to be supercharged. Certainly no crankcase scavenging is shown in either the 411 application or in official Lotus Publications which they have published on the World Wide Web. See Article entitled “Lotus Omnivore at Geneva”, written by John Simister, 9 Mar. 2009, published by Evo Magazine: http://www.evo.co.uk/news/evonews/234507/lotus_omnivore_at_geneva.html.

Lotus' Solution to the OTP of such emissions reductions in a two stroke cycle ICE is to adopt, among other things, supercharging, a mechanized trapping valve (to essentially provide for early exhaust valve closing), and variable compression ratio (VCR). Direct fuel injection (DFI) is adopted, as well as an intake throttle and a spark plug. The motor may operate in spark ignition (SI) mode or in the Homogeneous Charge Compression Ignition (HCCI) mode. With the Lotus Omnivore Engine, emissions reduction through retention of a controlled quantity of exhaust gas residuals is claimed to be achieved by the above mentioned hardware. Orbital Engine Co. (Assignee), U.S. Pat. No. 4,920,932 (1990), titled: “Relating to Controlling Emissions from Two Stroke Engines”. The ICE disclosed therein uses an exhaust port throttle valve to retain a desired amount of exhaust gas residuals. It is also crankcase scavenged. Emissions reduction through retention of controlled quantity of exhaust gas residuals is mentioned.

Bosch, Robert GmbH (Assignee), U.S. Pat. No. 7,231,892 B2 (2007), titled: “Method for Extending HCCI Load Range using a two-stroke cycle and variable valve actuation”. Discloses a hybrid two/four cycle engine, running in HCCI mode, which utilizes “fully variable and controllable valves, such as electro-hydraulic valves, whose timing and profile are completely decoupled from the piston position in the cylinder”. See 892 patent, page 2, lines 28-34, which also cite the potential use of generic “electro-magnetic” valves. The valve timing is controlled to give the desired quantity of exhaust gas residuals. A turbocharger is employed. Emissions reduction through retention of controlled quantity of exhaust gas residuals is mentioned.

Suffice it that the above mentioned several structures and methods in the prior art which solve Group “A” OTP do not include the use of an actively powered exhaust manifold fan in a two stroke cycle, normally aspirated, non-crankcase scavenged, ICE. However, there are several categories of prior art ICE's which are scavenged at least in part by exhaust vacuum, including the utilization of exhaust manifold fans. They are next examined to confirm that none of them have ever taught, suggested, or provided motivation as to solving the Group “A” OTP herein. It is emphasized that should one wish to reduce emissions in a two stroke cycle ICE by removing a discrete amount of exhaust gasses from its combustion chamber through a vacuum in its exhaust manifold during the scavenging process, then there is no need to complicate matters by simultaneously ramming pressurized air through the engine from the other side (i.e., the intake passage). As below discussed, such forced induction may cause effects such as “short circuiting” and or cause unnecessary or undesired mixing of the incoming air with exhaust gas product before the desired amount of exhaust product is actually removed. Either or both of these scenarios potentially reduces the degree of control that one otherwise possesses by dent of a properly selected exhaust fan vis a vis engine flow rate. Therefore, all Group “A” embodiments are normally aspirated and not crankcase scavenged (which also can create in cylinder turbulence when its intake port opens).

### Scavenging Generally

Two stroke cycle ICE's do not possess a so called “exhaust stroke” in which a piston nearly completely evacuates through positive displacement the exhaust gasses from the combustion chamber of an ICE, post combustion. Thus, a two stroke cycle ICE faces a combustion chamber and or cylinder containing a significant amount of exhaust products at the beginning of its scavenging process, which process is typically sandwiched between its power and compression strokes.

Several different apparatuses and methods for scavenging two stroke cycle ICE's are common. These include so called “crankcase scavenged” engines, where the bottom of the piston, in combination with void space in the crankcase, serves as a pump, and intake air is positively forced (i.e., “transferred”) to the combustion chamber via transfer port(s) cut into the cylinder wall. A second common structure and method of scavenging the two stroke cycle ICE utilizes a pressurized (i.e., above atmospheric pressure) intake charge, said pressure generated by a supercharger and or turbocharger.

It is common knowledge to those skilled in the art that a normally aspirated four stroke cycle ICE is, generally speaking, capable of being scavenged by the combination of its so called “intake” and “exhaust” piston strokes, and, in some instances, additionally by any intake and exhaust valve positive overlap which may be designed to occur. As a general rule, larger (positive) valve overlaps as such are more easily tolerated (that is, without detrimental scavenging effects of exhaust product back-flow) at higher engine revolutions and or mass air flows, while little or no valve overlap better suits low rpm's/mass air flows.

In a supercharged four stroke cycle ICE, scavenging occurs as above, but has the added assistance of pressurized intake air which potentially can even further rid the combustion chamber of any remaining exhaust products whilst packing it full of fresh intake charge air. As a result, a well designed supercharged four stroke cycle ICE (without undue intake/exhaust valve overlap) is typically well scavenged in terms of removing exhaust product and replacing the same with fresh incoming charge.

For turbocharged four stroke cycle ICE's, scavenging occurs once again as in the above described normally aspirated ICE, but has the added assistance of pressurized intake air which potentially can even further rid the combustion chamber of any remaining exhaust products whilst packing it full of fresh intake charge air, provided that excessive turbocharger back pressure does not occur. As a result, a well designed turbocharged four stroke cycle ICE without excessive valve overlap is also typically well scavenged.

In terms of scavenging both two and four stroke cycle ICE's, other arrangements in the prior art have been adopted wherein both a pressurized intake manifold and an active exhaust manifold vacuum pump have been utilized (see below references).

In terms of vacuum scavenging, the prior art used, initially, a passive mode of same which is described in more detail below. This mode consisted of utilizing exhaust wave combinations and interferences to coax a vacuum at the exhaust manifold of an ICE at some usually steady engine speed. Other structures and methods for creating a vacuum at an ICE's exhaust manifold over the years have been introduced. In none of them has there ever been a teaching, suggestion, motivation, let alone an issue, regarding the problem of retaining a certain quantity of spent exhaust gas product in the subject ICE with a mind's eye towards emissions reduction. Without exception as will be seen, such vacuum scavenged engines have instead structurally and methodologically focused on and otherwise taught ridding said combustion space of as much exhaust product as possible.

### Artifices and Methods Employing Passive Vacuum Waves to Scavenge ICE's

The prior art has examples of ICE's which adopt passive means (i.e., limited to using said ICE's exhaust energy) in order to scavenge. These examples include: the Benjamen patent, U.S. Pat. No. 3,162,999 (1964)) which utilizes a Venturi Effect to scavenge a watercraft ICE; the Berchtold patent, U.S. Pat. No. 3,180,077 (1965)) which utilizes a so called passive “wave machine” to scavenge an ICE, and the Duryea patent, U.S. Pat. No. 1,313,276 (1919) which claims to utilize passive fan blades in the exhaust manifold, which blades are powered exclusively by exhaust energy to scavenge. These are all undesirable since such passive form of vacuum creation/scavenging is limited to narrow rpm ranges and allows the operator virtually no control over the quantity of exhaust gas residuals retained.

### Artifices and Methods Employing Forced Induction in Combination with Exhaust Manifold Fans to Scavenge ICE's

The Brown patent, U.S. Pat. No. 1,586,778 (1925), discloses an ICE having a “blower feed” and “blower exhaust mechanism”. Brown 778 patent at page 1, lines 5-6. Brown appears to describe a four stroke cycle ICE. See Brown 778 patent at page 1, lines 92-93 (“ . . . upon the intake stroke of the piston.”). Note that a two stroke cycle ICE has no “intake stroke of the piston”. The so called “blower feed” is within the intake manifold of said ICE and the so called “blower exhaust mechanism” is within the exhaust manifold of said ICE. See Brown 778 patent at page 1, lines 44-45 (“Blowers A and B are interposed in the manifolds 5 and 6 respectively . . . . ”). The so called blower feed in Brown causes positive intake pressure, 778 patent at page 1, lines 80-82 (“ . . . The mixture is fed into the firing chamber of the cylinders so as to be slightly under pressure . . . . ”), and the so called blower exhaust mechanism “is disposed adjacent to the exhaust valves so as to suck the exhaust gases from the cylinders.” See 788 patent at page 1, lines 74-76.

Given the above, Brown discloses an ICE in combination with a mechanical intake air compressor and a mechanical exhaust manifold blower. Brown does not teach, suggest, nor motivate as to, let alone disclose, any artifice, method, or ICE control means whatsoever, whether automatic or manual, for trapping or otherwise retaining a discrete amount of exhaust product within the engine for use in the next engine cycle, for any purpose, let alone the reduction of NOx. Moreover, Brown, via its blower feed (and, of course, its four stroke cycle operation), is clearly capable of scavenging the engine without its blower exhaust mechanism, something which the two stroke cycle, normally aspirated, not crankcase scavenged, embodiments of Group “A” are not. For reasons already discussed, the forced induction aspect of Brown is undesirable in terms of optimally managing precise amounts of exhaust gas residuals to be retained when using an exhaust fan for emissions reduction in a two stroke cycle ICE.

The U.S. Pat. No. 2,861,556 of Bancel (1952) discloses a four stroke cycle ICE (page 1, line 3) possessing both an air compressor (page 2, lines 8-13) for intake air pressurization and an exhaust fan for creating a vacuum in the exhaust manifold (page 2, lines 25-29). Bancel does not teach, suggest, nor motivate as to, let alone disclose, any artifice, method, or ICE control means whatsoever, whether automatic or manual, for trapping or otherwise retaining a discrete amount of exhaust product within the engine for use in the next engine cycle, for any purpose, let alone the reduction of NOx. As was Brown, Bancel is also capable of scavenging the engine without its blower exhaust mechanism, something which the two stroke cycle, normally aspirated, not crankcase scavenged, embodiments of Group “A” are not. For reasons already discussed, the forced induction aspect of Bancel is undesirable in terms of optimally managing precise amounts of exhaust gas residuals to be retained when using an exhaust fan for emissions reduction in a two stroke cycle ICE.

Similarly, the U.S. Pat. No. 6,189,318 of Valisko (2001) describes what appears to be a four stroke cycle ICE. See Abstract, discussing both “exhaust” and “intake” strokes, neither of which are strokes occur in a two stroke cycle ICE. Similarly, the 318 patent also adopts an air compressor in the intake manifold and a vacuum pump in the exhaust manifold, and has no sensors and or controllers relating to, for example, exhaust manifold vacuum. See 318 patent at page 2, starting at line 29 “A compressor 18 is mounted to generate an increase in pressure inside the inlet manifold 15 so that fuel-air mixture is forced into the cylinders whenever the respective inlet valves are open”. Valisko does not teach, suggest, nor motivate as to, let alone disclose, any artifice, method, or ICE control means whatsoever, whether automatic or manual, for trapping or otherwise retaining a discrete amount of exhaust product within the engine for use in the next engine cycle, for any purpose, let alone the reduction of NOx. It otherwise suffers from the same problems just reviewed for the Brown and Bancel Patents. Zedan, U.S. Pat. No. 5,867,984 (1999), specifically discloses as its (at least ostensible) objects “accessories that may be incorporated into a conventionally designed combustion engine that boosts the evacuation of exhaust product from an engine's piston chamber(s) and potentiates the evacuation system's performance when incorporated downstream from the extreme heat containing exhaust product.” See 984 patent at page 1, lines 9-17. Zedan expresses not one thought as to, let alone any teaching, suggestion, or motivation respecting, the retention of a discrete or even substantial amount of exhaust product during vacuum scavenging to be used to reduce NOx emissions.

The above said Zedan “accessories” at least in part relate to its so called “gas extraction system”, page 2, line 3, which is comprised of its thrice named “exhaust evacuation booster 60”, page 2, line 37, “evacuation fan 60”, page 2, line 39, and “booster fan 60”, page 2, line 42-42. “In principal, the invention provides a boost or booster 60 for assisting the evacuation of exhaust from a piston chamber 20 established within a piston cylinder 15.” See 984 patent at page 2, lines 31-36.

In contrast to every disclosed embodiment herein pertaining to Group “A”, each of which relies on its exhaust fan for engine functionality as well as for emissions reduction through residual exhaust gas retention, said “gas extraction system”, see page 2, line 31, of the 984 patent is singly disclosed in combination with an otherwise independently functioning engine. Namely, “it is an exhaust gas extraction system 10 that can be incorporated into an internal combustion engine at the time of manufacture or subsequently as a retro-fit feature.” Similarly, “[t]he present invention does not alter the conventional operation of a combustion engine's piston-cylinder configuration.” See 984 patent, page 3, lines 26-28. Also, the name “booster fan” in and of itself implies that said fan only provides an assist to the engine, rather than perform an integral function. The 984 patent goes on to confirm beyond doubt that its singly disclosed engine embodiment does not exclusively rely upon said evacuation booster to enable engine functionality. See 984 patent, at page 4, lines 54-56, “[i]t is also possible that the operation of the fan 60 be discontinued during times when its affects are not required.” To the extent said exhaust fan was necessary to the functioning of the engine in the first place, then its “affects” as it were would always be required. Given the above, there is no teaching, suggestion, nor motivation in the 984 patent that its exhaust fan- or any exhaust fan for that matter—be used as a means to scavenge an engine having no other means of scavenging. Rather, the 984 patent teaches the opposite, namely, that its booster fan is supplemental to engine's operation, meaning that it cannot be the exclusive form of engine scavenging. It is also clear that the 984 patent neither structurally, functionally, nor methodologically discloses or suggests the retention of any spent exhaust gas product in order to control or reduce emissions in a two stroke cycle, normally aspirated, non-crankcase scavenged, ICE. Rather, its object appears to be just the opposite, namely, to rid as much of the exhaust gas product as possible at all times from its engine. To wit, “[t]he present invention's inclusion of the booster fan 60 assists the evacuation of the spent exhaust products from the chamber 20. By applying the vacuum created by the fan 60, a more complete evacuation of the exhaust products is assured.” See 984 patent at page 4, lines 3-7.

There is no teaching, suggestion, or motivation in the 984 patent that its single embodiment engine or its several accessories be used to accomplish a controlled retention of the oft times substantial quantity of exhaust gas residuals normally associated with emissions reductions in a two stroke cycle ICE. More generally, nothing in the 984 patent otherwise expressly discloses structure and or methodologies specifically referencing NOx emissions reduction in a two a stroke cycle ICE.

The 984 patent raises the natural question of whether it describes a two or a four stroke cycle ICE, since the same is never expressly disclosed. However, because of the above mentioned disclosure that the engine can operate without said exhaust booster fan, an automotive engineer may safely reason that said 984 patent describes either a four stroke cycle ICE, a two stroke cycle ICE which has forced induction, or a two stroke cycle ICE which is crankcase scavenged. This is because all of the just mentioned ICE types are capable, as is the ICE described in the 984 patent, of operation without an exhaust fan. However, simple deduction eliminates the possibility that the 984 patent describes a two stroke cycle normally aspirated ICE without crankcase scavenging, because this last ICE cannot operate without exhaust vacuum supplied and the engine of the 984 patent admittedly can.

Functionally and methodologically, the singly disclosed principal of operation of the engine described in the 984 patent is one wherein (positive) exhaust and intake valve overlap is not permitted nor disclosed. Rather, the 984 ICE actually depends on negative valve overlap as such for its singly described operational cycle to be enabled. This is because said cycle depends upon “capturing” a vacuum created by the exhaust fan, then using same to suck in fresh charge, clearly utilizing negative intake and exhaust valve overlap, as follows: “As the piston 27 continues to move downward from the intermediate position (P3), the dilution valve 70 will be closed thereby permitting the vacuum developed by the booster fan 60 to be communicated across the exhaust exit 50 and applied to the piston chamber 20. This suction and vacuum may be continued until the piston head 30 reaches its lowermost position (P5). At this time, the variable interior volume of the chamber 20 will be at its greatest and optimum vacuum may be applied by the booster fan 60 at that time. The vacuum or lower pressure condition may be captured in the chamber 20 by closing the exhaust exit valve 50 while the vacuum is applied thereto. After the closing of the exhaust valve 55, the fuel inlet 40 may be opened by appropriately configuring the inlet valve 45 to an open position. In this manner, the vacuum that has been established within a chamber 20 may be exerted upon the fuel inlet 40 to pull the needed fuel mixture into the chamber 20 in preparation for the next upward compression stroke of the piston head 30. After the chamber 20 has been sufficiently filled with fuel mixture, the inlet valve 45 may be closed thereby once again establishing the closed chamber 20 within the piston cylinder 15. This cyclical procedure is repeated rapidly thereby resulting in the “running” of the internal combustion engine when a plurality of pistons act in cooperation with one another.” See 984 patent at page 4, lines 26-50. The cyclic process just described pertaining to the 984 patent's singly disclosed embodiment and singly disclosed mode of operation does not allow both the intake and the exhaust valves to both be opened at the same time (i.e., positive valve overlap).

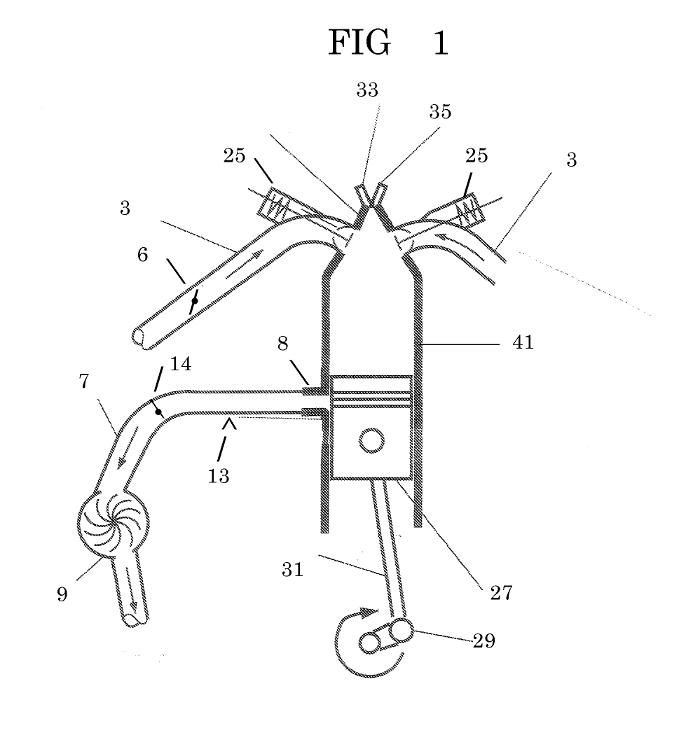

Even if a different (undisclosed) method were to be adopted with regard to the 984 patent's ICE valve timing which would provide positive valve overlap, which is not suggested and which would be completely opposite to its negative valve overlap methodology singly disclosed therein, the physical structural arrangement of the intake and exhaust ports in and of themselves would cause short circuiting of intake air straight across the cylinder (from left to right, See FIG. 1, Zedan patent) into the exhaust, with little or no chance of scavenging in a controlled way those exhaust products holed up in the upper and or lower reaches of the cylinder, once again making precise control of exhaust gas residuals neigh impossible. Given the above, it cannot be said that the 984 patent structure and methods disclosed are even capable of retaining a controlled amount of exhaust product so as to better reduce NOx emissions.

Additionally, it may be reasonably inferred that the exhaust fan in the 984 patent is a constant flow rate fan. Applicant bases his assessment respecting said constant flow rate fan exclusively upon the fact that the 984 patent never mentions that its fan flow rate may be varied, and because of the statement that “[d]uring this operation, the booster fan 60 may continuously run and its effect upon the piston chamber 20 will be governed by operation of the exhaust exit valve 55 and dilution valve 70.”). See 984 patent at page 4, lines 51-54. This appears to be the only portion of the patent which speaks to controlling the amount of vacuum exerted upon the exhaust port.

Lastly, the so called “dilution inlet controller 70” (read: a valve, see 984 patent at page 2, lines 55-56) itself is antithetical to achievement of precise control of the retained exhaust product, since it clearly adds yet another engine parameter variable one would have to sense and potentially control regarding the goal of retaining of a desired amount of exhaust product.

### Group “A” ICE Primary Structural Configuration and Theory of Operation of Disclosed Embodiments

At least FIGS. 1, 3, and 5 herein refer to ICE embodiments belonging to Group “A”.

All normally aspirated, not crankcase scavenged, two stroke cycle ICE disclosed embodiments of Group “A” must necessarily be capable of some degree of intake and exhaust valve (positive) overlap at some point in time between its power (piston downstroke) stroke and its compression (piston upstroke) stroke within its complete two stroke cycle. By having what amounts to an open conduit completely through the engine during the time of the scavenging process, the prior art variability of intake manifold pressures and of exhaust manifold back pressure (above atmospheric), not to mention the turbulence created by forced induction modes of scavenging, is reduced. Thus, by adopting Group “A” engine architecture, the number of engine parameters which need to be measured and controlled are reduced because of known, measurable, more consistent pressures in said intake and exhaust manifolds.

For example, it is known that four fundamental variables need to be controlled for proper two stroke cycle emissions reduction, and they are: mass of fresh intake charge; mass of inert exhaust products retained; composite temperature of the charge, and fuel equivalence ratio. And while compression ratio is certainly relevant, its relevance is mainly that it influences the temperature of the combined charge (consisting of air, exhaust gas, and fuel), said temperature being the entity which actually causes autoignition when said charge constituents are correctly proportioned (i.e., in HCCI Mode).

The known pressure differential created across said engine “conduit” as it were thereby causes fresh intake air to start to fill the combustion space starting at the intake valve whilst exhaust products begin to seep out from the exhaust valve. The scavenging process may thus occur in a more controlled, more predictable, less turbulent, fashion as compared to a two stroke cycle ICE possessing the complex pressure uncertainties created by forced induction or crankcase scavenging, let alone in combination with so called “trapping”.

It is known in ICE circles that an incoming stream of pressurized charge air often tends to blow straight through or around stagnant hot exhaust product in an ICE combustion chamber without fully displacing same, depending upon in cylinder geometry, thus making the prediction and control of the actual exhaust product removed quite difficult when forced induction is used for scavenging a two stroke cycle ICE. Short circuiting and irreversible mixing will likely occur. However, a long, not overly narrow (say, with bore and stroke dimensions approximating a standard ICE cylinder) clear glass tube filed with dense smoke can be used to show the following. Namely, that a slight vacuum (e.g., as is easily supplied by a fan's intake side) applied to one side of said tube whilst the other side is left to the atmosphere will result in the smoke moving out of the tube on the vacuum side with a cleaner moving boundary between the fresh incoming air and the smoke than if said smoke removal is attempted by the use of high pressure instead being applied to clear out the smoke. In the later case, pressurized charge air may tend to barrel or “short circuit” down the center of the tube leaving much of the smoke around it in place.

An actively powered exhaust fan allows for maintainable exhaust manifold (average) vacuum, and a normally aspirated intake gives another known pressure (atmospheric) to not have to measure nor introduce into an algorithm in a control module. These certainties combine to allow a higher degree of control with regard to the amount of fresh charge admitted and exhaust product exited than possible with the prior art structures, and controlling the dilution proportions between fresh charge and exhaust gasses is important in an HCCI engine. For engines designed to be run at constant speed and load, they can be calibrated to work with a constant flow fan in their exhaust manifold. For engines designed to operate over a range of speeds and loads, a variable speed fan is preferred. As seen in the disclosed embodiments herein, a throttle valve may also be added in the exhaust pipe between the exhaust valve and exhaust fan to temper the suction to said exhaust valve during scavenging. An intake manifold throttle valve may also be used.

Such above control is optionally beneficial with regard to the proper operation of those two stroke cycle ICE's disclosed herein which operate in either the spark ignition (SI) mode or in the Homogeneous Charge Compression Ignition (HCCI) mode. Generally, allowing for a particular amount of hot retained exhaust products in said two stroke ICE is paramount to NOx and soot emissions reduction. Said amount of fresh charge allowed in, and the amount of exhaust product allowed out, of the ICE's combustion chamber may be augmented by the use of the same prior art (VVT) technology generically described in the above cited Bosch 892 patent at page 2, lines 28-34. Other forms of VVT, such as switchable cam profiles, may also be used to augment fan control of the amount of exhaust gas residuals and fresh incoming air. Optionally, and in lieu of VVT, the system described herein can be made to draw (that's, suck) more or less air into, and exhaust product out of, said ICE by simply varying the amount of vacuum in the exhaust manifold (i.e., speed up or slow down the fan), even for an engine possessing fixed positive intake and exhaust valve timing (i.e., without VVT).

Also, for HCCI Mode, any generic prior art form of achieving a variable compression ratio (“VCR”) may also be used to increase heat at low rpm's when the engine may not be producing sufficient residual exhaust gas heat, or otherwise used to reduce compression and temperature at high engine speed. For example, a mechanism such as that disclosed in the expired U.S. Pat. No. 4,738,230 of Johnson may be used.

### Non-Obviousness of Said Group “A” Inventive Step

The prior art respecting two stroke cycle ICE's which seek to retain a desired portion of residual exhaust gasses (for the purpose of at least NOx emissions reduction) does not teach, suggest, nor otherwise motivate as to the utilization of an actively powered fan in an ICE exhaust manifold at least during a period of intake and exhaust passage positive overlap, in combination with normal aspiration (and or non-crankcase scavenging), to achieve such exhaust gas retention. Rather, to reduce such emissions, the prior art teaches (what physically amounts to) the exact opposite by utilizing either forced induction (and or crankcase scavenging), in combination with said EGR and or “trapping”, to simultaneously add, displace, and or retain residual exhaust gasses.

Neither do those prior art engines (reviewed herein) which in any way utilize exhaust fans similarly suggest anything respecting at least NOx emissions reduction by virtue of retention of a portion of exhaust gasses in two stroke cycle normally aspirated, non-crankcase scavenged, ICE's. Once again, in this vein the prior art teaches the opposite, namely, how to rid as much residual exhaust gas from the engine cycle to cycle, without thought, means, nor objects remotely relating to the OTP solved herein which seeks to retain such gas.

The above prior art, which includes the best efforts of industry stalwarts such as Orbital, Bosch, and Lotus, is ample evidence that present market trends, forces, suggestions, teachings, and motivations, all point toward a business as usual scenario, namely, more “trapping”, “EGR”, and more “forced induction” slanted solutions to the OTP set forth herein. Moreover, the fact that both private and government funding for two stroke cycle ICE SI and HCCI development continues to pour in for the exact same gas “trapping” and “forced induction” solutions provides little incentive or motivation for fundamental change in strategy, and consequently encourages those in the art to simply stay the course. How to achieve precise control over the amount of desired retained exhaust gas product in the combustion space of a two stroke cycle ICE is better fostered by a clean sheet approach.

There has never been any teaching, suggestion, nor motivation regarding using a normally aspirated, not crankcase scavenged, two stroke cycle ICE (i.e., no forced induction of any means) whose scavenging is induced by fan creating a vacuum in its exhaust manifold, to control its desired quantity of exhaust gas residuals and fresh air intake to achieve at least NOx emissions reduction, whether in a SI or HCCI Mode.

The reality is that the pressure of exhaust gas at the time of trapping (see Lotus 411 application above) has been difficult, if not impossible, to predict, and the state of the art in affordable real time (including near instantaneous) in cylinder pressure/temperature measurement and subsequent control is still not mature. Because, for one, said cylinder pressure at the time of “trapping” is difficult to predict and control, so too is the mass of the resulting gas which is actually “trapped” at any given time. This phenomenon is only further complicated by necessarily forcing pressurized intake charge through the engine. Such processes together or separately virtually ensure an inconsistent and non-repeatable mass of trapped exhaust product cycle to cycle in a two stroke cycle ICE, no matter the efficiency of the trapping mechanism itself nor the (present) sophistication of its control system(s). Thus, if market motivation exists apart from business as usual, then it is to develop faster, real time control systems to hopefully ameliorate the inherently inconsistent combustion conditions (resulting in premature and or otherwise unpredictable detonation for example in HCCI mode) aided and abetted by the above said existing structures and methods which have married themselves into the prior art.

### Part II—Group “A” Best Mode and Detailed Description

### Explanation of Disclosed Embodiments

FIG. 1—Partial view of a two stroke cycle normally aspirated ICE, without any crankcase to cylinder transfer ports, showing a uniflow design, with arrows indicating flow direction, shown comprised of intake manifold 3, optional intake throttle 6, exhaust manifold 7, exhaust port 8, actively powered exhaust fan 9, engine parameter sensor 13, optional exhaust throttle 14, intake valves 25, piston 27, crankshaft 29, connecting rod 31, optional spark plug 33, fuel injector 35, and cylinder 41.

### General Discussion Pertaining to Embodiments Disclosed Herein

Many of the optional features are here shown in combination with Group “A” basic ICE architecture. See above discussion and the Claims herein to determine which features constitute the basic mode of said FIG. 1. Note that throttles are shown in both the exhaust and intake manifolds. As previously discussed, the position of any of said elements is not absolute. For example, the fuel injector can be where shown, or may be situated in the lower cylinder region. Moreover, said fuel injector could be in the intake manifold (i.e., port injection). In FIG. 1, fresh air enters through the overhead valves shown, and exits at the exhaust port and into the exhaust fan. Said valves can have fixed or variable lift, timing, and duration.

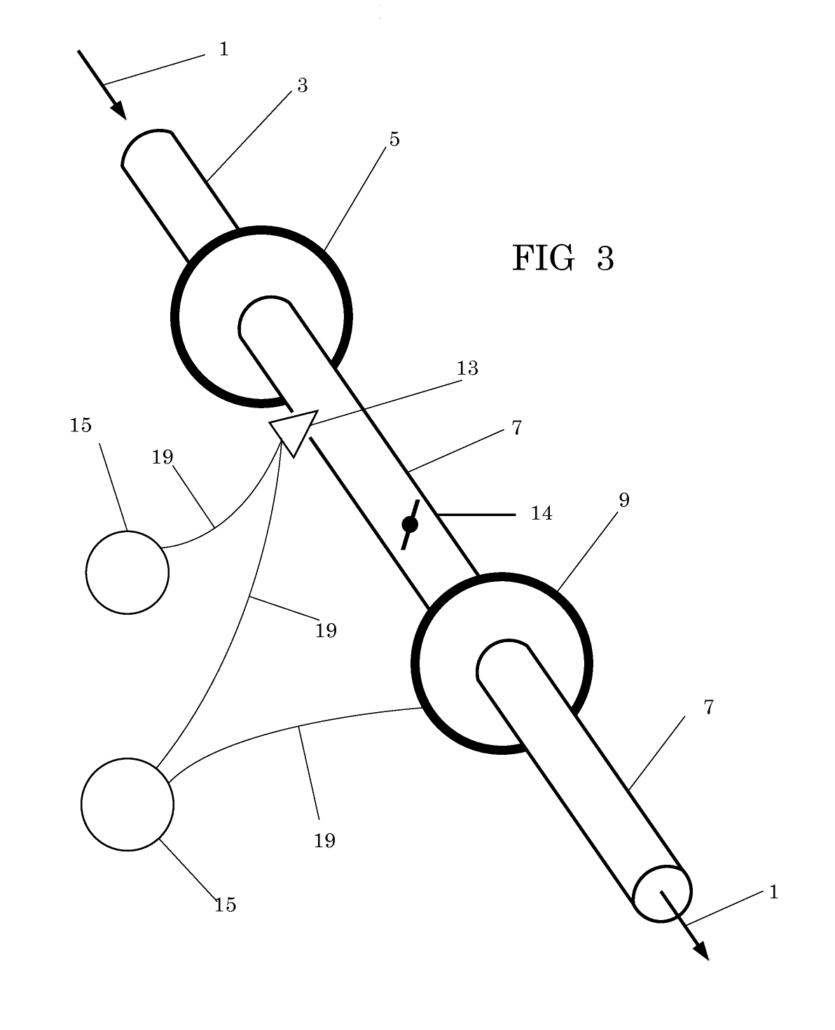

FIG. 3—conceptual view of normally aspirated generic two stroke cycle ICE 5, with arrows 1 indicating flow direction, shown comprised of ICE intake manifold 3, exhaust manifold 7, exhaust fan 9, optional engine parameter sensor 13, optional exhaust throttle 14, sensor signal controller 15, controller(s) 17, and connections 19.

FIG. 3 gives a general idea of how a sensor system may be used to control the fan flow rate. And while such process is discussed in detail in the Claims herein, basically an engine parameter is measured (i.e., absolute pressure) at 13, and the sensor signal is transmitted then controlled by sensor signal controller 15, such that said controller may then regulate the fan.

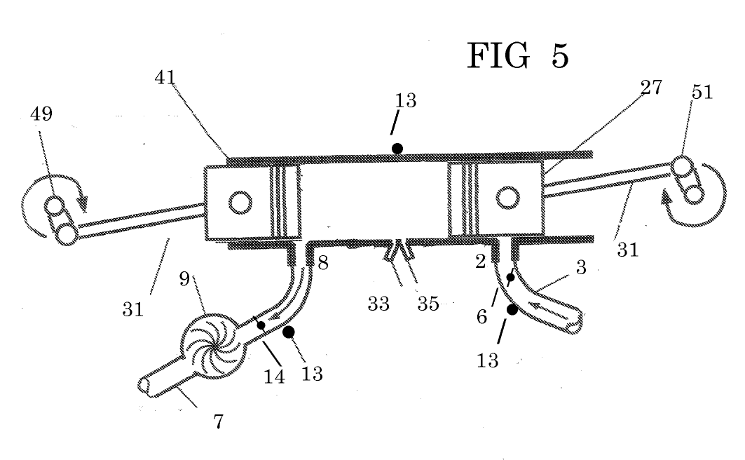

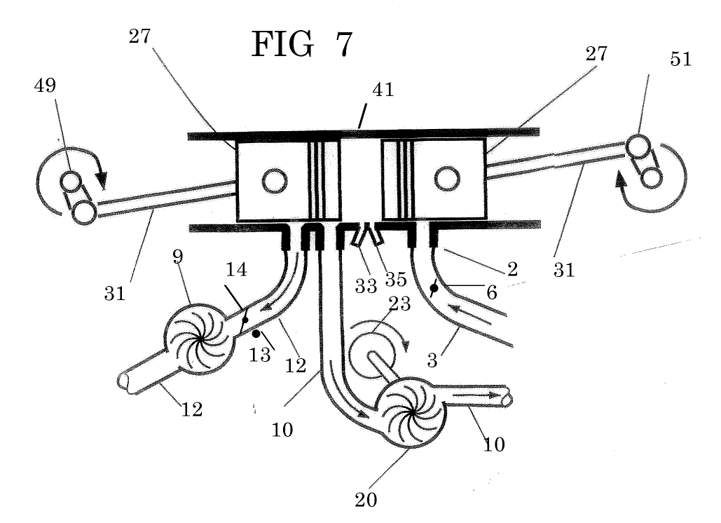

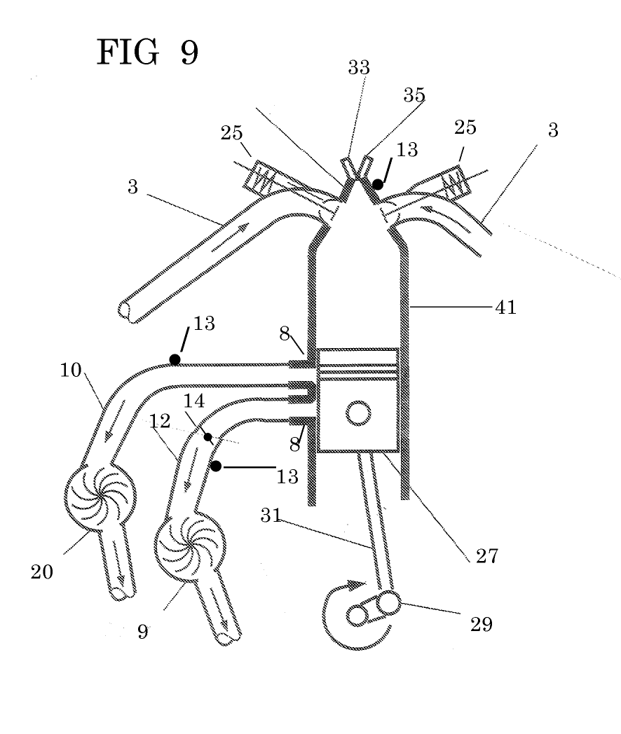

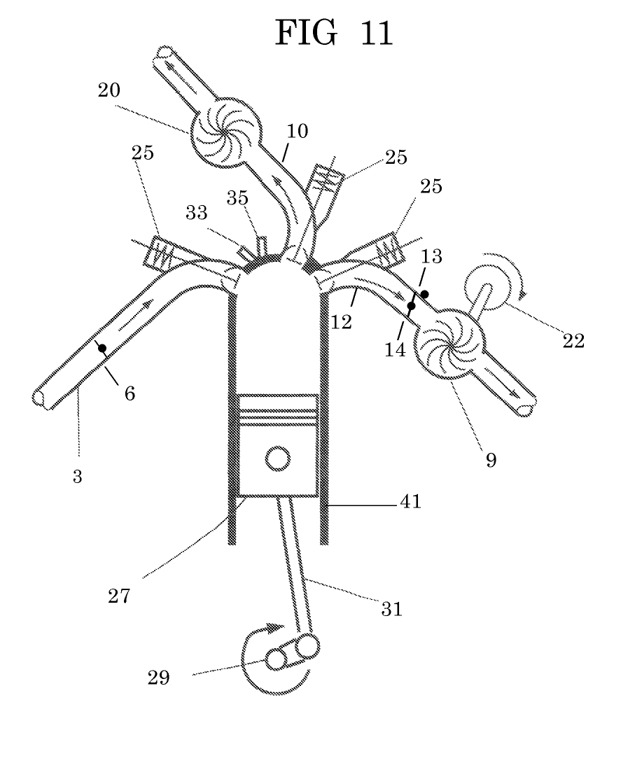

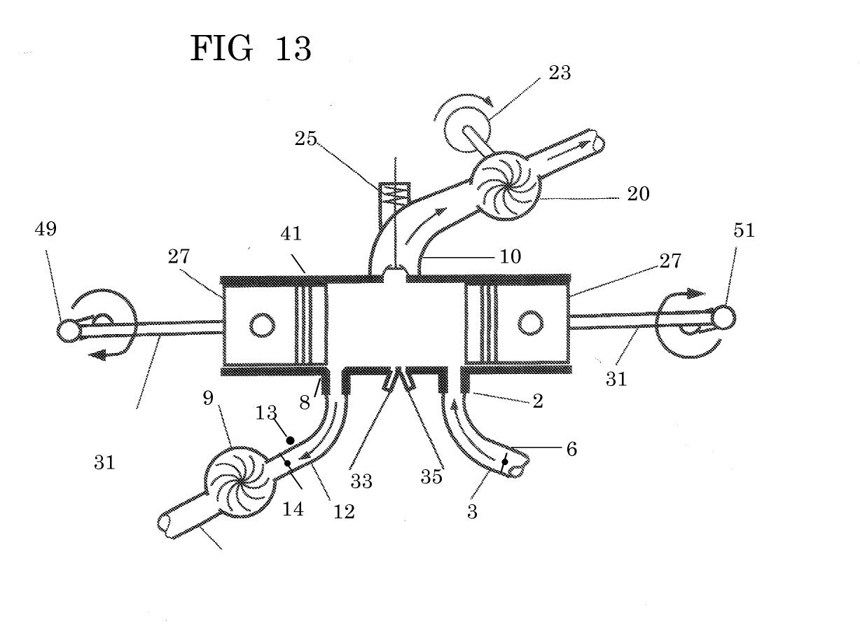

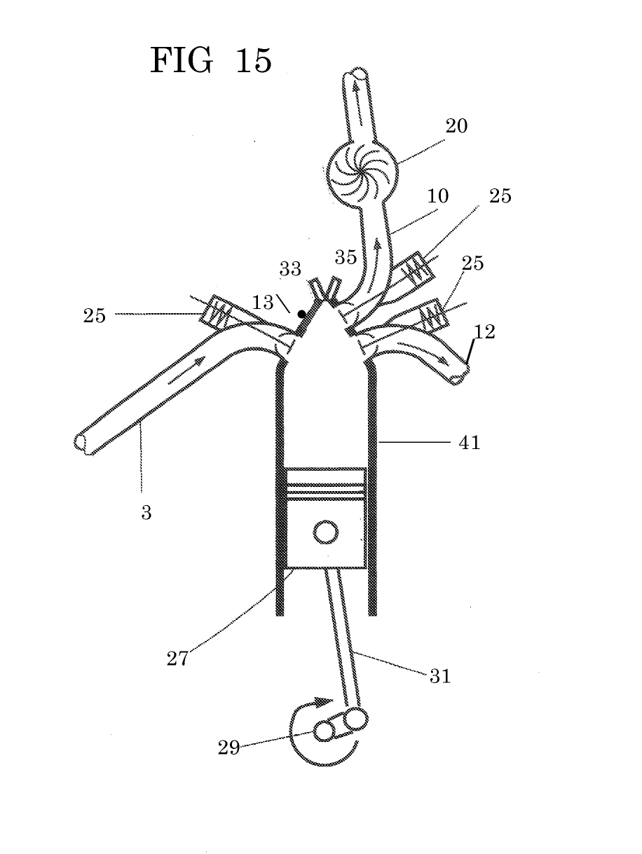

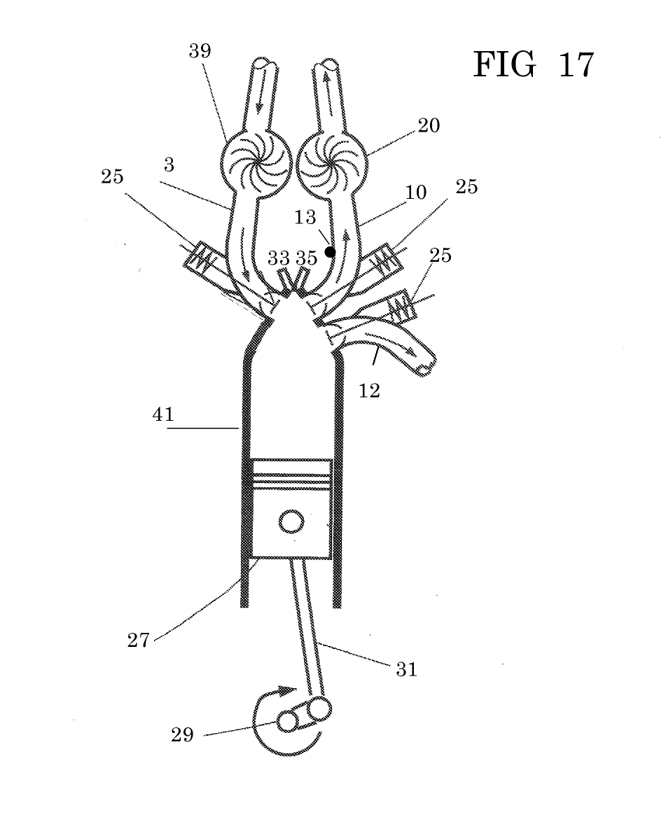

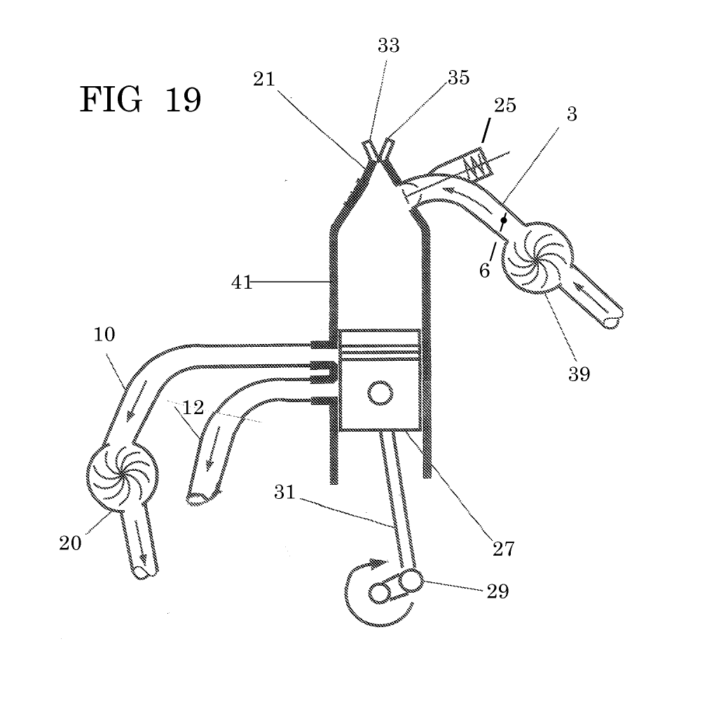

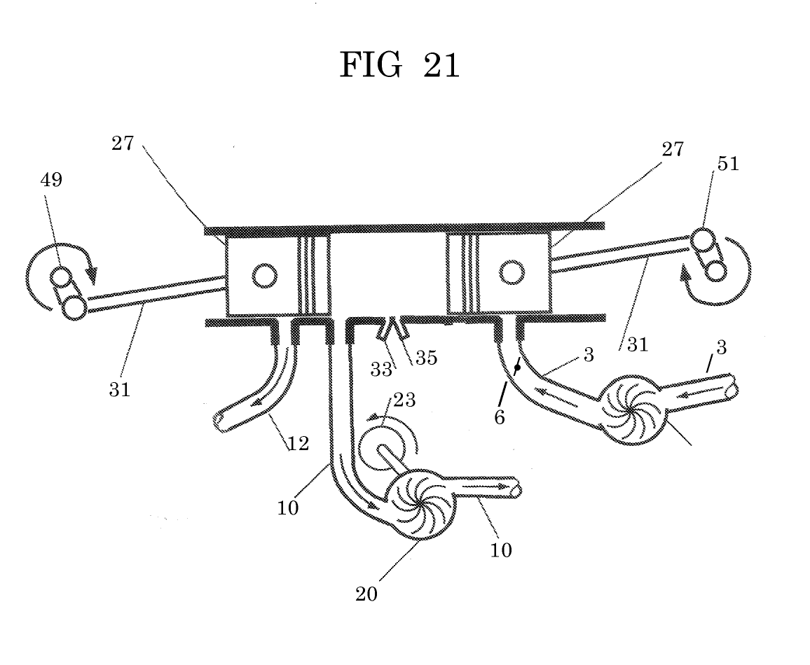

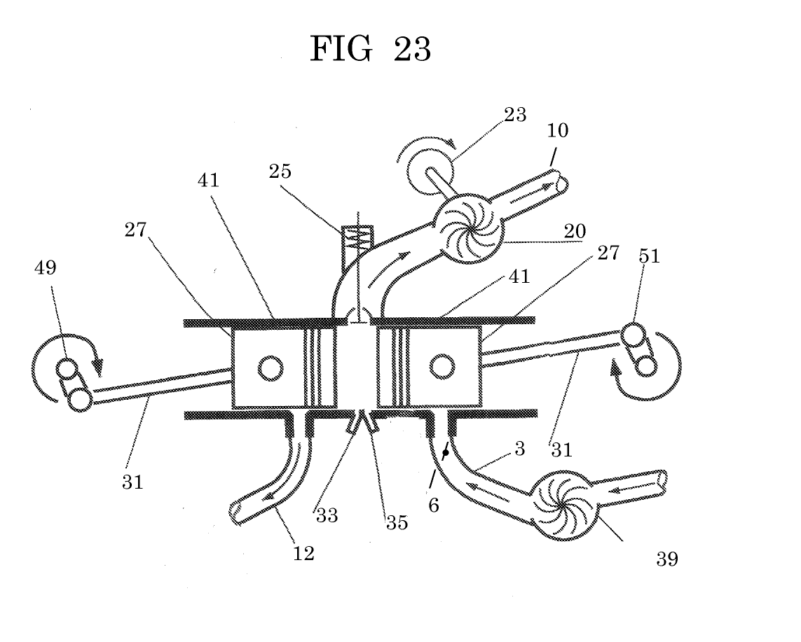

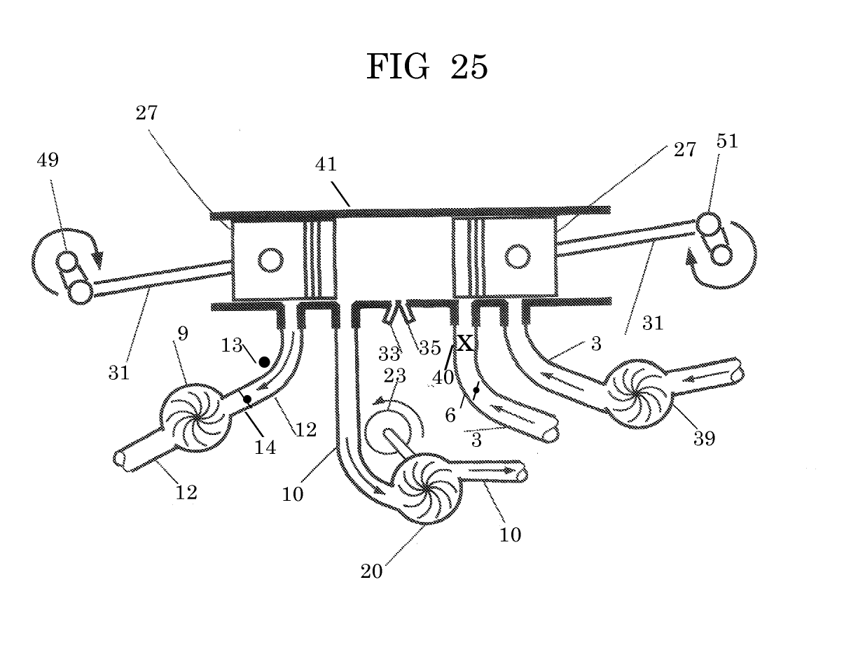

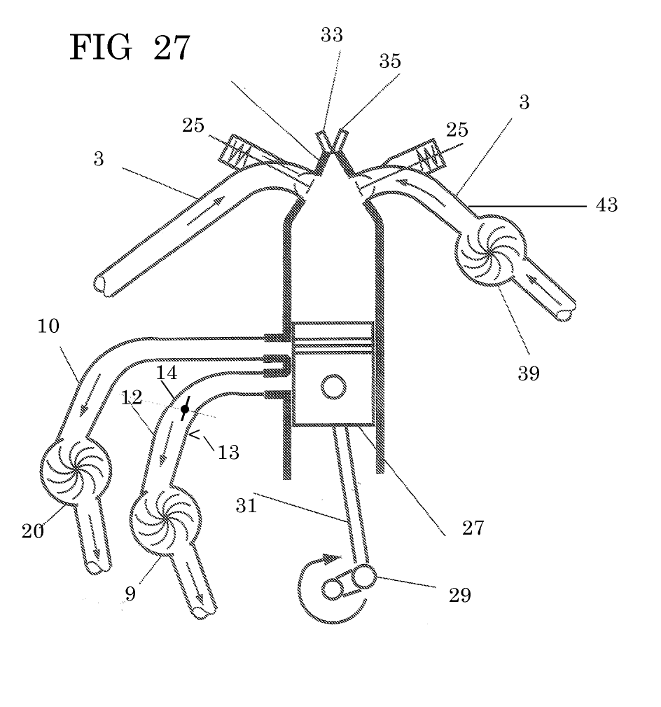

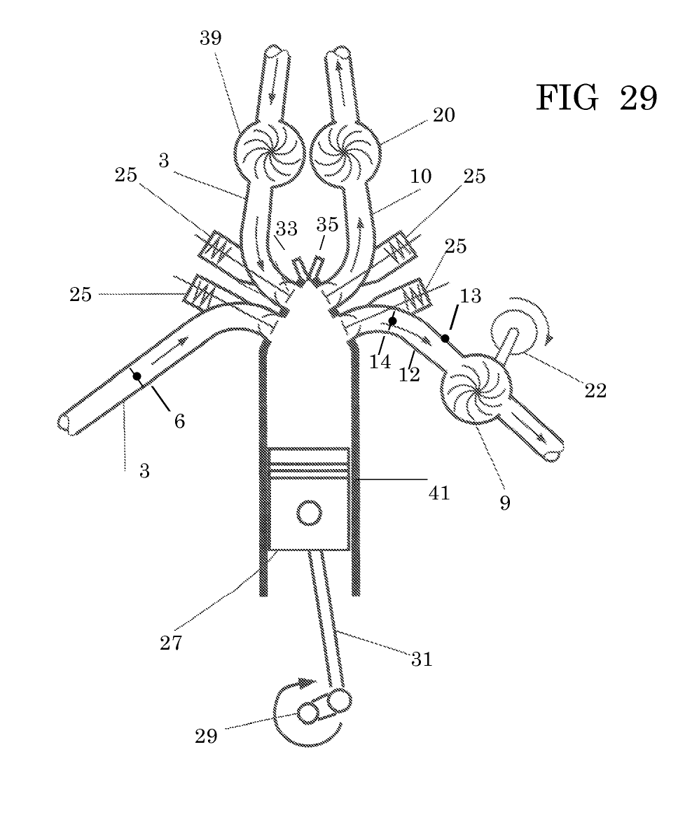

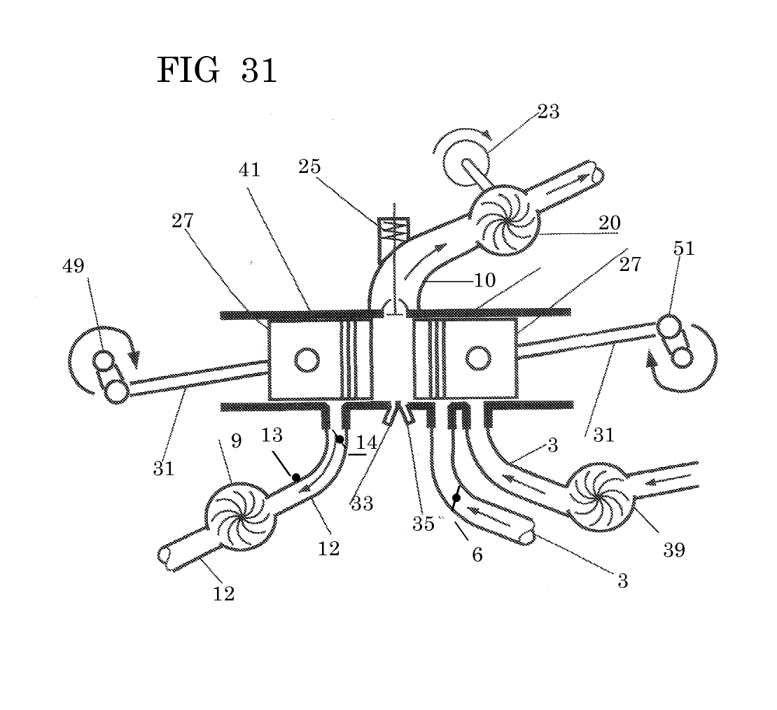

FIG. 5—conceptual view of normally aspirated opposed piston two stroke cycle uniflow ICE with arrows indicating flow direction, shown comprised of intake port 2, intake manifold 3, optional intake throttle 6, exhaust manifold 7, exhaust port 8, actively powered exhaust fan 9, engine parameter sensor 13, optional exhaust throttle 14, pistons 27, connecting rod 31, optional spark plug 33, fuel injector 35, cylinder 41, left crankshaft 49, and right crankshaft 51.

It is seen that fresh charge enters the engine from the right through intake manifold 3, and exhaust product is removed on the left through the exhaust manifold with exhaust fan. Piston positions are not absolute. Throttles again shown. Engine parameter sensor 13 in this example is positioned to sample combustion chamber parameters.

### GROUP “B”

### Group “B” Sub-Title-Reduced CO₂ Emissions Enlarged Expansion Ratio Internal Combustion Engine Embodiments

### Group “B” Introduction

Each disclosed embodiment pertaining to said Group “B” herein is a normally aspirated, internal combustion engine (ICE), which physically separates its exhaust products into a first and second exhaust manifold, whereby higher energy combustion chamber exhaust gas is routed via the first of said manifolds to a turbine, and the remaining lower energy combustion chamber exhaust gas is routed through said second exhaust manifold. As seen in the separately disclosed and claimed embodiments, said second manifold may go to the atmosphere or, in other embodiments, to an actively powered exhaust fan.

The prior art of ICE's has utilized several structures and or methodologies which attempt to extract more power from in cylinder combustion generated gas expansion. One of these methods and structures involves what is known as the Atkinson Cycle. Production and sales of motor vehicles incorporating the so called “Atkinson Cycle” is ongoing with, for example, Honda and Toyota. The Honda and Toyota “Atkinson Cycle” engines are examples of four stroke cycle gasoline (typically) fueled, spark ignited, OHV, ICE powered vehicles which achieve the Atkinson Cycle via an early intake valve closing, which unfortunately also reduces compression ratio, and, hence, power. Current market motivation is to adopt better so called Variable Valve and Timing Systems (“VVT”) for current piston ICE's to better control this Atkinson Cycle, and this was the technology most recently adopted by Honda for its new line of four cylinder engines for its “Accord” model automobile. It is common knowledge among automotive engineers that both the Honda and Toyota production engines employing the Atkinson Cycle do so under part load scenarios, because said Atkinson Cycle produces less power as above noted.

### Group “B”, Brief Description of the Drawings

FIG. 7—conceptual view of normally aspirated opposed piston two stroke cycle uniflow ICE with arrows indicating flow direction, shown comprised of intake port 2, intake manifold 3, optional intake throttle 6, actively powered exhaust fan 9, first exhaust manifold 10, second exhaust manifold 12, optional engine parameter sensor 13, optional exhaust throttle 14, exhaust turbine 20, electrical generator 23, pistons 27, connecting rod 31, optional spark plug 33, fuel injector 35, cylinder 41, left crankshaft 49, and right crankshaft 51. FIG. 9—conceptual view of normally aspirated overhead (intake) valve uniflow two stroke cycle ICE with arrows indicating flow direction, shown comprised of intake manifold 3, actively powered exhaust fan 9, first exhaust manifold 10, second exhaust manifold 12, optional engine parameter sensor 13, optional exhaust throttle 14, exhaust turbine 20, valves 25, piston 27, crankshaft 29, connecting rod 31, optional spark plug 33, fuel injector 35, and cylinder 41.

FIG. 11—conceptual view of normally aspirated overhead (intake) valve two stroke cycle ICE with arrows indicating flow direction, shown comprised of intake manifold 3, optional intake throttle 6, actively powered exhaust fan 9, first exhaust manifold 10, second exhaust manifold 12, optional engine parameter sensor 13, optional exhaust throttle 14, exhaust turbine 20, mechanical exhaust fan drive 22, valves 25, piston 27, crankshaft 29, connecting rod 31, optional spark plug 33, fuel injector 35, and cylinder 41.

FIG. 13—conceptual view of normally aspirated opposed piston two stroke cycle uniflow ICE with arrows indicating flow direction, shown comprised of intake port 2, intake manifold 3, optional intake throttle 6, exhaust port 8, actively powered exhaust fan 9, first exhaust manifold 10, second exhaust manifold 12, optional engine parameter sensor 13, optional exhaust throttle 14, exhaust turbine 20, electrical generator 23, pistons 27, connecting rod 31, optional spark plug 33, fuel injector 35, cylinder 41, left crankshaft 49, and right crankshaft 51.

FIG. 15—conceptual view of normally aspirated overhead valve four stroke cycle ICE with arrows indicating flow direction, shown comprised of intake manifold 3, first exhaust manifold 10, second exhaust manifold 12, optional engine parameter sensor 13, exhaust turbine 20, valves 25, piston 27, crankshaft 29, connecting rod 31, optional spark plug 33, fuel injector 35, and cylinder 41.

### Part I—Group “B” Best Mode and Detailed Description

### Overview of Group “B” Disclosed Embodiment(s)' Common Limitations

All Group “B” embodiments disclosed herein possess at least the following structural common features which distinguish them from the prior art:

Normally aspirated, ICE, comprised of at least one piston, at least one cylinder, at least one combustion chamber, at least one intake and at least one exhaust passage to said at least one combustion chamber, at least one intake manifold, and at least one turbine, which ICE physically routes its exhaust products into a first and second exhaust manifold, whereby higher energy combustion chamber exhaust gas is routed via the first of said manifolds to said turbine, and the remaining lower energy combustion chamber exhaust gas is routed through said second exhaust manifold. As seen in the separately disclosed embodiments, said second manifold may go to the atmosphere or, in other embodiments, to an actively powered exhaust fan.

### Preview of the OTP Solved by all Group “B” Embodiments

The reduction of CO₂ emissions (i.e, increased fuel economy) as pertains to a normally aspirated ICE by increasing its actual or its effective so called expansion ratio, without incurring the loss of power normally associated with the so called “Atkinson Cycle” which is so employed in the prior art to increase said expansion ratio.

Said objective technical problem (OTP) was formulated by and through distinguishing the common features of all Group “B” embodiments disclosed herein from those features pertaining to the closest prior art (also disclosed herein). Said OTP is well recognized in the prior art and or is otherwise capable of being deduced therefrom by a person skilled in the art of automotive engineering.

### Group “B” Advantages and or Alternatives as Compared to the Prior Art

Major investment and tooling respecting incorporating the so called “Atkinson Cycle” into production automobiles, such as Honda and Toyota, is ongoing. These automobiles which utilize four stroke cycle ICE's, achieve higher fuel economy (and, hence, CO₂ reduction) via utilization of the Atkinson Cycle. Said reduction is accomplished through delayed intake valve closing, which unfortunately also reduces the engine's effective compression ratio and, hence, power, making such mode suitable primarily for low load situations.

Apart from the above described common structural features which distinguish all Group “B” embodiments disclosed herein from the prior art, each of said Group “B” embodiments constitutes an alternative to, and or a technical improvement over, the prior art, and each possesses the following inventive functional and or methodological features which further distinguishes them from the prior art:

The reduction of CO₂ emissions in normally aspirated ICE's (through increased ICE fuel economy), by utilization of split exhaust manifolds and a turbine to effectively increase said ICE's expansion ratio achieved during its power stroke, and to accomplish the foregoing without the loss of power associated with the Atkinson Cycle.

### Preview of Inventive Step Generally Pertaining to all Group “B” Embodiments

The reduction of CO₂ emissions in normally aspirated ICE's (through increased ICE fuel economy), by utilization of split exhaust manifolds and a turbine to effectively increase said ICE's expansion ratio achieved during its power stroke, and to accomplish the foregoing the without loss of power associated with the Atkinson Cycle.

### Rationale in Part for Inventive Step

The physical separation of said ICE exhaust flows as above allows for effectively increasing the expansion ratio of high pressure exhaust product whilst suffering little or no loss of power. This is because, in addition to the above said higher energy combustion chamber exhaust gas discharge to the turbine situated in said first exhaust manifold, said ICE is also scavenged through said second exhaust manifold at least during a period of intake and exhaust passage positive overlap, and, as a consequence thereof, the gasses routed through said second exhaust manifold do not encounter turbine back pressure. Thus, not only does the engine not face a (Atkinson Cycle Type) power robbing effective reduction of its compression ratio whilst it is experiencing an increased effective expansion ratio leading to said improved fuel efficiency (which includes CO₂ emissions reduction), the use of the turbine itself is cleansed of one of its characteristic drawbacks, namely, turbine back pressure which itself is known to rob power. Even if a prior art structure, function, and or methodology relating to increasing said expansion ratio could solve the above stated OTP, the inventive step herein nonetheless still constitutes an alternative structure, function, and or methodology to solve said OTP.

Relatedly, in no way does this application seek to criticize or discredit manipulation of valve timing as above to reduce compression ratio. Valve timing as such may optionally be used to augment certain of those Group “B” embodiments disclosed herein, depending upon the embodiment, albeit that structure which allows such manipulation of valve timing as such is not part of the above disclosed Group “B” common elements.

### The Closest Prior Art Pertaining to all Group “B” Embodiments

It is common knowledge among automotive engineers that the ICE's of current Honda and Toyota model lines which employ Atkinson Cycle (by virtue of late intake valve closing), do so under a reduced power regime.

We therefore examine the underpinnings of the OTP solved by said Group “B” disclosed embodiments by a review of the closest prior art references pertaining to a Normally Aspirated ICE which separates its higher and lower energy exhaust products into two separate manifolds. The U.S. Pat. No. 4,969,329 of Bolton (1990), describes an invention which “provides exhaust gas segregating or separating means for a two cycle gasoline engine of the air scavenging type in combination with an emission control system which uses the separated gases to better control exhaust emissions. See 329 patent at page 1, line 66 to page 2, line 2. After separation, and heat exchange, the gases are reunited for processing in a catalytic converter. Nowhere does the 329 patent teach, suggest, nor motivate as to physically separating the exhaust products of a normally aspirated ICE into a first and second exhaust manifold, whereby higher energy combustion chamber exhaust gas is routed via the first of said manifolds to a turbine, and the remaining lower energy combustion chamber exhaust gas is routed via the second of said manifolds to, depending upon the embodiment, an actively powered exhaust fan or to the atmosphere. The 329 patent moreover does not lay claim to reduced CO₂ emissions by and through an increase in fuel efficiency, and the OTP hinted at to be solved by said 329 patent relates to optimizing exhaust gasses to work with catalytic converters. See 329 patent, page 1, lines 41 “[t]here remains, however, an additional problem of exhaust emission control which bears upon use in automotive vehicles with catalytic converters.”

### Group “B” ICE Primary Structural Configuration and Theory of Operation of Disclosed Embodiment Group “B”

All above mentioned embodiments disclosed herein under Group “B” are normally aspirated ICE's which physically separate their exhaust products into a first and second exhaust manifold, whereby higher energy combustion chamber exhaust gas is routed via the first of said manifolds to a turbine, and some remaining portion of lower energy combustion chamber exhaust gas is routed through said second exhaust manifold. As seen in the separately disclosed and claimed Group “B” embodiments, said second manifold may lead to the atmosphere or, in other embodiments, to an actively powered exhaust fan. That said, the combustion chamber needs at least one intake passage for fresh air to enter and at least two exhaust passages for exhaust products to exit. At least one of said exhaust passages must lead to said first exhaust manifold and at least one other of said exhaust passages must lead to said second exhaust manifold.

The foregoing allows for effectively increasing the expansion ratio of high pressure exhaust product in a normally aspirated ICE whilst suffering no loss of power due to an otherwise unnecessary reduction of said ICE's compression ratio (like does the Atkinson). Nor does the solution herein to the Group “B” OTP induce those complications normally associated with forced induction (i.e., supercharging and or turbocharging). These include increased exhaust back pressure and or otherwise troublesome wave mechanics, either or both of which may result in ICE engine performance issues, such as excessive heat, increased pumping losses, and or poor scavenging.

Thus, the fuel efficiency is improved and hence CO₂ emissions are reduced. This is because, shortly following or even overlapping with the above said higher energy discharge into said first exhaust manifold containing the turbine, said ICE is additionally scavenged during a period of intake and exhaust passage positive overlap by and through said second exhaust manifold. Given this, the engine when scavenging does not face the normal power robbing back pressure which would otherwise be associated with such enhanced energy recovery when utilizing a turbine without the segregated exhaust manifolds. The foregoing does not require said ICE to lower its effective or actual compression ratio at any time, including when routing exhaust energy to the turbine. Consequently, the problem of low power when utilizing an enhanced expansion ratio Cycle is solved.

No examples of prior art engines so adopting said Atkinson Cycle teaches, suggests, or motivates as to using the turbine and split exhaust manifold solution set forth herein.

### Non-Obviousness of Said Group “B” Inventive Step

The prior art does not teach, suggest nor motivate as to the solution here posed to the above stated OTP.

### Part II—Group “A” Best Mode and Detailed Description

### Explanation of Disclosed Embodiments

FIG. 7—conceptual view of normally aspirated opposed piston two stroke cycle uniflow ICE with arrows indicating flow direction, shown comprised of intake port 2, air intake 3, optional intake throttle 6, actively powered exhaust fan 9, first exhaust manifold 10, second exhaust manifold 12, optional engine parameter sensor 13, optional exhaust throttle 14, exhaust turbine 20, electrical generator 23, pistons 27, connecting rod 31, optional spark plug 33, fuel injector 35, cylinder 41, left crankshaft 49, and right crankshaft 51.

FIG. 9—conceptual view of normally aspirated overhead (intake) valve uniflow two stroke cycle ICE with arrows indicating flow direction, shown comprised of air intake 3, actively powered exhaust fan 9, first exhaust manifold 10, second exhaust manifold 12, optional engine parameter sensor 13, optional exhaust throttle 14, exhaust turbine 20, valves 25, piston 27, crankshaft 29, connecting rod 31, optional spark plug 33, fuel injector 35, and cylinder 41.

FIG. 11—conceptual view of normally aspirated overhead (intake) valve two stroke cycle ICE with arrows indicating flow direction, shown comprised of air intake 3, optional intake throttle 6, actively powered exhaust fan 9, first exhaust manifold 10, second exhaust manifold 12, optional engine parameter sensor 13, optional exhaust throttle 14, exhaust turbine 20, mechanical exhaust fan drive 22, valves 25, piston 27, crankshaft 29, connecting rod 31, optional spark plug 33, fuel injector 35, and cylinder 41.

FIG. 13—conceptual view of normally aspirated opposed piston two stroke cycle uniflow ICE with arrows indicating flow direction, shown comprised of intake port 2, air intake 3, optional intake throttle 6, exhaust port 8, actively powered exhaust fan 9, first exhaust manifold 10, second exhaust manifold 12, optional engine parameter sensor 13, optional exhaust throttle 14, exhaust turbine 20, electrical generator 23, pistons 27, connecting rod 31, optional spark plug 33, fuel injector 35, cylinder 41, left crankshaft 49, and right crankshaft 51.

FIG. 15—conceptual view of normally aspirated overhead valve four stroke cycle ICE with arrows indicating flow direction, shown comprised of air intake 3, first exhaust manifold 10, second exhaust manifold 12, optional engine parameter sensor 13, exhaust turbine 20, valves 25, piston 27, crankshaft 29, connecting rod 31, optional spark plug 33, fuel injector 35, and cylinder 41.

### GROUP “C”

### Group “C” Sub-Title-Reduced CO₂ Emissions from, and Increased Performance of, High Power Density Internal Combustion Engines

### Group “C” Introduction

Each disclosed embodiment pertaining to said Group “C” herein is a forced induction, internal combustion engine (ICE), which physically separates its exhaust products into a first and second exhaust manifold, whereby higher energy combustion chamber exhaust gas is routed via the first of said manifolds to a turbine, and the remaining lower energy combustion chamber exhaust gas is routed through said second exhaust manifold. As seen in the separately disclosed and claimed embodiments, said second manifold's exhaust gasses may be routed to the atmosphere or, in other embodiments, to an actively powered exhaust fan. As also seen, some Group “C” embodiments may additionally have a second (ambient) intake manifold. The turbocharging of an ICE, or, more generally, the combination of a piston ICE with an energy recovery turbine in its exhaust, has historically involved a trade-off. Namely, maximizing the energy recoverable from said exhaust (which is otherwise wasted to the atmosphere in a business as usual scenario) versus the consequent ICE management problems caused by said recovery, which problems may include increased exhaust back pressure and or otherwise troublesome wave mechanics, either or both of which may result in ICE engine performance issues. Said engine performance issues may include, but are not necessarily limited to, a delay in engine responsiveness to an acceleration request (i.e., the well known so called “turbo lag” problem), excessive heat, increased pumping losses, and or poor scavenging.

Therefore, in preview, two Objective Technical Problems (OTP's) known in the art of utilizing exhaust turbines in connection with ICE's are:

(1) increasing ICE fuel efficiency (i.e., reducing CO₂ emissions) by utilizing a turbine to capture exhaust gas energy otherwise wasted, whilst

(2) minimizing the turbine(s)' potential negative impact on at least one ICE performance characteristic, such as decreased engine responsiveness (i.e., so called “turbo lag”).

It may be argued that the above is in reality but one objective technical problem (OTP), namely, optimizing the balancing act between (1) and (2).

As seen herein, said objective technical problem (OTP) was formulated by and through distinguishing the common features of all Group “C” embodiments disclosed herein from those features pertaining to the closest prior art (also disclosed herein). Said OTP is well recognized in the prior art and or is otherwise capable of being deduced therefrom by a person skilled in the art of automotive engineering.

### Group “C”, Brief Description of the Drawings

FIG. 17—conceptual view of forced induction overhead valve four stroke cycle ICE with arrows indicating flow direction, shown comprised of intake manifold 3, first exhaust manifold 10, second exhaust manifold 12, exhaust turbine 20, valves 25, piston 27, crankshaft 29, connecting rod 31, optional spark plug 33, fuel injector 35, intake air compressor 39, and cylinder 41.

FIG. 19—conceptual view of forced induction overhead (intake) valve two stroke cycle uniflow ICE with arrows indicating flow direction, shown comprised of intake manifold 3, optional intake throttle 6, first exhaust manifold 10, second exhaust manifold 12, exhaust turbine 20, cylinder head 21, valve 25, piston 27, crankshaft 29, connecting rod 31, optional spark plug 33, fuel injector 35, intake air compressor 39, and cylinder 41.

FIG. 21—conceptual view of forced induction opposed piston two stroke cycle uniflow ICE with arrows indicating flow direction, shown comprised of intake manifold 3, optional intake throttle 6, first exhaust manifold 10, second exhaust manifold 12, exhaust turbine 20, electrical generator 23, pistons 27, connecting rod 31, optional spark plug 33, fuel injector 35, intake air compressor 39, cylinder 41, left crankshaft 49, and right crankshaft 51.

FIG. 23—conceptual view of forced induction opposed piston two stroke cycle uniflow ICE with arrows indicating flow direction, shown comprised of intake manifold 3, optional intake throttle 6, first exhaust manifold 10, second exhaust manifold 12, exhaust turbine 20, electrical generator 23, pistons 27, connecting rod 31, optional spark plug 33, fuel injector 35, intake air compressor 39, cylinder 41, left crankshaft 49, and right crankshaft 51.

FIG. 25—conceptual view of forced induction opposed piston two stroke cycle uniflow ICE with arrows indicating flow direction, shown comprised of intake manifold 3, optional intake throttle 6, exhaust fan 9, first exhaust manifold 10, second exhaust manifold 12, optional engine parameter sensor 13, optional exhaust throttle 14, exhaust turbine 20, electrical generator 23, valve 25, pistons 27, connecting rod 31, optional spark plug 33, fuel injector 35, intake air compressor 39, check valve 40, cylinder 41, left crankshaft 49, and right crankshaft 51.

FIG. 27—conceptual view of forced induction overhead valve uniflow two stroke cycle ICE with arrows indicating flow direction, shown comprised of intake manifold 3, exhaust fan 9, first exhaust manifold 10, second exhaust manifold 12, optional engine parameter sensor 13, optional exhaust throttle 14, exhaust turbine 20, valves 25, piston 27, crankshaft 29, connecting rod 31, optional spark plug 33, fuel injector 35, intake air compressor 39, and cylinder 41.

FIG. 29—conceptual view of forced induction overhead valve two stroke cycle ICE with arrows indicating flow direction, shown comprised of intake manifold 3, exhaust fan 9, first exhaust manifold 10, second exhaust manifold 12, optional engine parameter sensor 13, optional exhaust throttle 14, exhaust turbine 20, mechanical exhaust fan drive 22, valves 25, piston 27, crankshaft 29, connecting rod 31, optional spark plug 33, fuel injector 35, intake air compressor 39, and cylinder 41.

FIG. 31—conceptual view of forced induction opposed piston two stroke cycle uniflow ICE with arrows indicating flow direction, shown comprised of intake manifold 3, optional intake throttle 6, exhaust fan 9, first exhaust manifold 10, second exhaust manifold 12, optional engine parameter sensor 13, optional exhaust throttle 14, exhaust turbine 20, electrical generator 23, pistons 27, connecting rod 31, optional spark plug 33, fuel injector 35, intake air compressor 39, cylinder 41, left crankshaft 49, and right crankshaft 51.

### Group “C” Best Mode and Detailed Description

### Overview of Group “C” Disclosed Embodiment(s)' Common Limitations

All Group “C” embodiments disclosed herein possess at least the following structural common features which distinguish them from the prior art:

Forced induction ICE's, comprised of at least one piston, at least one cylinder, at least one combustion chamber, at least one intake and at least two exhaust passages to said at least one combustion chamber, at least one turbine, at least one air compressor working in cooperation with at least one intake manifold, which ICE physically routes its exhaust products into a first and second exhaust manifold, whereby higher energy combustion chamber exhaust gas is routed via the first of said exhaust manifolds to a turbine, and the remaining lower energy combustion chamber exhaust gas is routed through the second exhaust manifold. As seen in the separately disclosed embodiments, said second manifold may go to the atmosphere or, in other embodiments, to an actively powered exhaust fan.

Preview of the OTP solved by all Group “C” embodiments.

Two Objective Technical Problems (OTP's) known in the art of utilizing exhaust turbines in connection with ICE's are:

(1) increasing ICE fuel efficiency (i.e., reducing CO₂ emissions) by utilizing a turbine to capture exhaust gas energy otherwise wasted, whilst

(2) minimizing the turbine(s)' consequent negative impact on various ICE performance characteristics, including decreased engine responsiveness such as so called “turbo lag”.

It may be argued that the above is in reality but one objective technical problem (OTP), namely, optimizing the balancing act between (1) and (2).

Said objective technical problem (OTP) was formulated by and through distinguishing the common features of all Group “C” embodiments disclosed herein from those features pertaining to the closest prior art (also disclosed herein). Said OTP is well recognized in the prior art and or is otherwise capable of being deduced therefrom by a person skilled in the art of automotive engineering.

### Group “C” Advantages and or Alternatives as Compared to the Prior Art

The turbocharging of an ICE has historically involved a trade-off. Namely, maximizing the energy recoverable by said turbine from said ICE exhaust (which is otherwise wasted to the atmosphere in a business as usual scenario) versus the consequent ICE management problems caused by said recovery, which problems may include increased exhaust back pressure and or otherwise troublesome wave mechanics, either or both of which may result in ICE engine performance issues. Said engine performance issues may include, but are not necessarily limited to, a delay in engine responsiveness to an acceleration request (i.e., the well known so called “turbo lag” problem), excessive heat, increased pumping losses, and or poor scavenging. By optimizing both energy recovery and low pressure scavenging, Group “C” embodiments are advantageous over the prior art.

Group “C” embodiments may have yet additional structure, function, and or methodology further distinguishing them from the prior art, and each of said Group “C” embodiments constitutes an alternative to, and or a technical improvement over, the prior art.

### Preview of Inventive Steps Generally Pertaining to all Group “C” Embodiments

### Inventive Steps

Usage of said twin exhaust manifolds, only one of which contains a turbine, to achieve the above said OTP, of maximizing energy recovery from exhaust gasses while not being burdened by turbine back pressures. Under Group “C”, the timing of the exhaust passage which opens to the turbine should occur as early in the power stroke as feasible. This allows the maximum bleed down of cylinder pressure into the turbine such that said pressure is optimally reduced to turbine back pressure near or at the end of the power stroke. Depending upon the cycle of operation, such opening position of said exhaust can vary. For example, in an HCCI mode, combustion occurs nearly instantaneously, and, therefore, said opening may be advanced as compared to SI mode where (usually) the first 15-20 degrees after top dead center are consumed with a still burning flame front. To avoid such flame front impinging on the turbine, the engineer can opt to position said exhaust passage leading to the first exhaust manifold (and turbine) just outside of said area. Moreover, and as seen herein, rather than a turbocharger per se being utilized in said first exhaust manifold, a turbine generator working in connection with an energy storage unit, such as a battery may be used. A turbine which is combined with a planetary drive linked to the engine's output may also be used. Either of these last to can solve so called turbo overpressure situation. Moreover, by combining the above with the vacuum scavenge capabilities shown in Group “A”, Group “C” embodiments are advantageous in terms of HCCI and or standard SI two stroke cycle operation.

Two stroke cycle Group “C” embodiments which operate in the HCCI or spark ignition (SI) mode also will possess: an exhaust fan working in cooperation with the second exhaust manifold common to all Group C embodiments, and an additional intake manifold/passage which uses ambient air. This configuration solves the OTP by: increasing fuel economy and thus reducing CO₂ emissions through both exhaust energy recovery via turbine and through utilization of said CVC, while also ameliorating the above stated performance issues typically created by the use of an exhaust turbine in connection with an ICE through the use of Group C's standard dual exhaust manifold as described herein (which as discussed reduces exhaust back pressure.

### Group “C” Embodiments May be Two or Four Stroke Cycle and May Operate in HCCI or SI Modes

### The Closest Prior Art Pertaining to all Group “C” Embodiments

Patent application Publication of Vuk, App 2009/0223220—Discloses an ICE which utilizes a variable exhaust valve opening directing exhaust gasses to turbo-generator rather than a turbocharger, and has only a single exhaust manifold. Effectively solves problem of overpressure, but not turbine exhaust back pressure hindering performance.

U.S. Pat. No. 6,460,337 of Olofsson (Saab Assignee), 2002—

Describes a four cycle ICE utilizing the so called “Miller Cycle” in combination with two separate exhaust manifolds, the first of which has a turbocharger, and the second of which does not. Each manifold is connected to the combustion space by its own exhaust valve. The 337 patent sets forth the prior art of separate exhaust passages vis a vis turbocharged ICE's. To wit: “ . . . it is previously known from GB 2 185 286 to divide the exhaust-gas flow so that only the high-pressure pulse goes to the exhaust-gas turbine. In this way, disruptive pressure pulses are eliminated and the negative low-pressure cycle is converted into a positive low-pressure cycle. This is achieved by virtue of the fact that there are at least two exhaust valves in each cylinder, which open differently and feed different exhaust manifolds.”

While no formal Objective Technical Problem (OTP) is stated in the 337 patent, it can be gleaned that a substantial problem sought to be solved therein by the use of its dual exhaust manifold structural arrangement in combination with its “Miller Cycle” is to address the well known “overpressure” situation which occurs at high load/engine speeds in turbocharged ICE applications. In the prior art, overpressure was sometimes addressed with a so called “waste gate” which simply vented (wasted) excess turbocharger pressure at high engine speeds/loads, but which itself had limitations. The 337 patent states in describing its accomplishments: “[t]he result is better ventilation of the cylinder, by means of which the proportion of residual gases is reduced. The combustion is better and ignition can be set earlier as knocking only appears at a higher pressure than previously. As the load increases, pressure limitations are required because of knocking, as a result of which the charging pressure must be limited at higher loads. This has a negative effect on the performance of the engine.” See 337 patent, page 1, lines 54-61. Moreover, under “Objects of the Invention”, it is stated that “[s]till another object is to achieve better performance of the internal combustion engine at high speed.” See 337 patent at page 1, lines 64-66. At page 2, lines 24-28 it is also stated that “[t]he combination of divided exhaust-gas period and the method selected for charging the cylinder (Miller principal) consequently makes possible an improvement in performance at higher engine speed and high power but presupposes good variable valve control.” Although not expressly stated, that the only ICE disclosed embodiments in the 337 patent are of the four stroke cycle ilk is seen throughout the patent by its multiple discussions of valve timing unique to four stroke cycle engines, and by FIGS. 2A, 2B, 3A, and 3B, which clearly depict a four stroke cycle valve timing sequence.

Suffice it that the 337 patent errs to the side of engine performance, rather than maximum energy recovery, lest it would have a turbo in its second exhaust manifold also, and that fact is not lost in the following discussion respecting the several pending US Caterpillar Applications.

US 2009/0241540 Patent Application Publication, and US 2011/0154819 Patent Application Publication (which claims to be a so called “continuation-in-part” of 0241540), both by Roble and both assigned to Caterpillar—At least for the purposes of this prior art discussion, these Applications are virtually indistinguishable, thus only the 819 is here discussed. The 819 application Publication describes what appears to be a four cycle ICE utilizing two separate exhaust manifolds, both of which contain a so called “exhaust energy recovery assembly” (i.e., turbine or turbocharger). Some ambiguity is created throughout said 540 and 819 Applications because they both fail to commit with any definiteness as to what structure is actually presented and or where said structure is actually presented, by the use of the term “may” in virtually every sentence describing every substantive element of every embodiment in its “Detailed Description”. See 819 application from paragraph [29] to paragraph [77]. For example, “[t]he exhaust energy recovery assembly 40 may be located in at least the first exhaust branch 110. In some embodiments, the exhaust energy recovering assembly 40 may also be located in the second exhaust branch”. See 819 application at [032].

The above point is made in order to contrast the 819 application's so called “Detailed Description” with its teachings, which are clearly definite. Namely, the 819 application indubitably teaches away from scenarios wherein only one of said two separate exhaust manifolds contains an energy recovery device. We know this because said application specifically criticizes the structure employed in the above discussed 337 (Saab) patent in terms of exhaust energy recovery. To wit, after a long discussion describing said Saab patent, the 819 Application states that “ . . . although the [Saab] system includes divided exhaust-gas discharge through the first and second groups of exhaust valves, the portion of exhaust gases from the second group of exhaust valves is simply discharged through the exhaust pipe without passing through any energy recovery devices. This portion, which could contain a significant amount of the total energy produced during an engine cycle, is thus wasted in the system of the '337 patent. The system and method of the present disclosure are directed toward improvements in the existing technology”. See 819 application, at [10] and [11]. These teachings reasonably suggests that the sine qua non of the 819 application is in fact maximizing energy recovery by employment of energy recovery devices in each of its two separate exhaust manifolds (as opposed to employing said energy recovery device in only one of its two separate manifolds as did Saab in pursuance of a performance related end). Otherwise, the use of two such devices would appear to be specifically disclaimed by Caterpillar, which is contra to its own teachings.

Given the above, it may be reasonably inferred that the OTP sought to be solved by the 819 application is maximizing exhaust gas energy recovery via a turbine in each of its two exhaust manifolds, said application being clearly critical of using only one such turbo in a dual exhaust manifold. Put differently, it is reasonable to infer that the 819 application errs towards maximizing the energy recovery half of the turbo riddle, as opposed to the engine performance half (i.e., “With such a reduction in the temperature increase, engine combustion efficiency [of the Saab Engine/Patent] may be improved. However, when considering exhaust energy recovery, the system of the '337 patent may have drawbacks.” See 819 application, paragraph [010]).

### US 2004/0089278 Patent Application Publication of Ekenberg—

Like the Saab patent as above, the 278 application describes an ICE with two separate exhaust manifolds, each of which is valved separately to the combustion chamber, and only one of which contains a turbocharger. The 278 application clearly implies that the objective technical problem which it seeks to solve relates to the to the modulation of high turbine pressures which oft times occurs. Said modulation is achieved by utilizing two separate exhaust manifolds, only one of which has the turbo, in combination with variable exhaust valve timing. The same allows for exhaust gasses to bypass the turbo when necessary so as not to build up undue pressure. See, generally, paragraphs [014]-[017] of the 278 application. Summarizing, the 278 application errs to the performance side rather than to the energy recovery side of the known turbo tradeoff.

### U.S. Pat. No. 6,595,183 of Olofsson (Saab Assignee), 2003—

Describes a four cycle ICE utilizing two separate exhaust manifolds, the first of which has a turbocharger, and the second of which does not, in combination with Variable Valve Timing (VVT). Each manifold is connected to the combustion space by its own exhaust valve. While no formal Objective Technical Problem (OTP) is stated in the 183 patent, it can be gleaned that a substantial problem sought to be solved therein by the use of its dual exhaust manifold structural arrangement is to address the performance related problem of “poor volumetric efficiency”, page 1, line 17-18, caused at full throttle by turbine back pressure. Again, this system allows a bypass of the turbo as necessary to improve engine flow characteristics. As such, exhaust energy recovery is sacrificed (via second manifold ducting) to gain performance. See general discussion page 1, lines 15-57 explaining how this apparatus bypasses said turbo by way of VVT.

### Group “C” ICE Primary Structural Configuration and Theory of Operation of Disclosed Embodiment Group “C”

All Group “C” embodiments effectively route higher energy combustion chamber exhaust gas discharge to a turbine, said first exhaust passage which leads to said turbine being biased as early as feasible in the power cycle. When combustion chamber gas pressure is practically reduced to a minimum at or near piston BDC, said Group “C” embodiments continue the engine scavenging process into a low pressure exhaust manifold thereby avoiding the high back pressure normally associated with attempting to ram exhaust gas through a turbine. As seen in the separately disclosed embodiments, said second manifold may go to the atmosphere or, in other embodiments, to an actively powered exhaust fan. Scavenging of the combustion chamber continues, and the same, depending upon the embodiment, may involve the use of a second (ambient) intake manifold in cooperation with an exhaust fan (cooperating with said second exhaust manifold). In other embodiments, there is no second intake manifold and the second exhaust manifold may have a fan, or in another embodiment, may not have such fan (i.e., runs to the atmosphere). As scavenging continues, the combustion chamber is filled with pressurized air from said air compressor. Positive overlap between the openings of any combination of said intake and or exhaust passages is permissible.

In all Group “C” embodiments described herein, the first exhaust manifold will lead to a turbine. Depending upon the embodiment, the second exhaust manifold may lead to an exhaust fan or to the atmosphere. Catalytic converter(s) if necessary for emissions purposes, are suitably positioned within the first and or second exhaust systems, and said exhaust systems may or may not be connected to each other, depending upon the disclosed embodiment.

Apart from the inclusion of said exhaust manifolds, said ICE is also methodologically modified in respect of said prior art so that it may now ensure completion of combustion either just before or during its piston dwell period at TDC, achieving a so called “constant volume combustion” (“CVC”) scenario. Said CVC scenario may then be effectuated, depending upon the disclosed embodiment, by utilization of the HCCI (or other effectively constant volume combustion) cycle. By so achieving complete combustion whilst the piston is effectively stationary and substantially at its TDC position, more of the power stroke which follows is made available for energy production, during which stroke expansion of exhaust gasses into the turbine(s) and against the piston occurs.

In all Group “C” embodiments described herein, the first exhaust manifold will lead to a turbine (other turbine apparatus separate embodiments are later separately described and separately claimed herein). Depending upon the embodiment, the second exhaust manifold may lead to an exhaust fan or to the atmosphere.

After initiation of said power stroke, partial scavenging is accomplished by exiting pressurized combusted gasses through the exhaust passage pertaining to said first exhaust manifold, which gasses impinge upon the turbine. Depending on the particular embodiment, the opening of said first exhaust passage, by valve actuation or cylinder port opening by a piston, may be timed, structured, and or calibrated so as to achieve a minimal residual cylinder gas pressure at the end of said power stroke (see discussion herein). Apart from said per se exhaust passage opening, the degree of actual opening (which will control flow rate once opened) is optionally controllable, depending on the embodiment, and bears relevance to optimally reducing such cylinder pressures as above. To the extent that said cylinder pressure can be reduced to turbine back pressure at the end of said power stroke, then the amount of energy recovered from said gasses of combustion will be maximized through their dual expansion as against both the turbine and the piston. As seen herein, ways to so control flow once said exhaust passage(s) are opened include so called “VVT” Systems and or variable exhaust throttle(s) situated downstream from an exhaust valve or port, depending upon the embodiment disclosed.

At some point near the end of the power stroke, additional scavenging then occurs by and through combustion product exiting through said second exhaust passage and into said second exhaust manifold. Depending upon the embodiment, either pressurized air (from, for example, a turbocharger compressor), or atmospheric air, is provided through separate combustion chamber intake passage(s) for said scavenging purpose. In one of these scenarios, ambient air is drawn in to the combustion chamber whilst exhaust product is sucked out of it via said second exhaust passage possessing a fan creating a vacuum. In another scavenging scenario, pressurized air is admitted into the combustion chamber forcing exhaust product out of said second exhaust passage and into the second exhaust system. In either case, after a desired amount of exhaust has been expelled, all exhaust passages have been closed whilst the admission of pressurized air continues until a desired intake charge of fresh air is achieved, at which point the intake passage so admitting said fresh charge is closed. Combustion then occurs as above and thus another engine cycle begins. Valves and or piston controlled ports, depending upon the embodiment, are included in the above structure, which valves and or ports open or close during a complete ICE cycle thereby allowing gas to flow through intake and exhaust passages. These valves and or ports may have fixed values respecting their opening and closing positions and or respecting their flow capacities, or said opening and closing may be variable, and overlap may or may not occur as and between any of said valves, all of the foregoing dependent upon the embodiment disclosed.

I claim:

1. A normally aspirated two stroke cycle internal combustion engine, comprising:
at least one piston;
at least one cylinder;
at least one combustion chamber;
at least one intake passage to said at least one combustion chamber;
at least one exhaust passage to said at least one combustion chamber;
at least one exhaust manifold cooperating with said at least one exhaust passage;
at least one actively powered fan cooperating with said at least one exhaust manifold;
said engine further structured to have said at least one intake passage and said at least one exhaust passage both open at at least one engine position;
said engine to not possess any crankcase to cylinder scavenging ports;
whereby said engine is capable of operation in a two stroke cycle Homogeneous Charge Compression Ignition mode.

2. A normally aspirated two stroke cycle internal combustion engine, comprising:
at least one piston;
at least one cylinder;
at least one combustion chamber;
at least one intake passage to said at least one combustion chamber;
at least one exhaust passage to said at least one combustion chamber;
at least one exhaust manifold cooperating with said at least one exhaust passage;
at least one actively powered fan cooperating with said at least one exhaust manifold;
at least one spark plug;
said engine further structured to have said at least one intake passage and said at least one exhaust passage both open at at least one engine position;
said engine to not possess any crankcase to cylinder scavenging ports;
whereby said engine is capable of operation in a two stroke cycle spark ignition mode.

3. A normally aspirated four stroke cycle internal combustion engine, comprising:
at least one piston;
at least one cylinder;
at least one combustion chamber;
at least one intake passage to said at least one combustion chamber;
at least two separate exhaust passages to said at least one combustion chamber;
a first exhaust manifold cooperating with at least one of said exhaust passages;
a second exhaust manifold cooperating with at least one of said exhaust passages;
at least one turbine cooperating with said first exhaust manifold;
at least one actively powered fan cooperating with said second exhaust manifold;
at least one spark plug;
said ICE further structured to have said at least one intake passage and at least one exhaust passage both open at at least one engine position;
whereby said engine is capable of operation in a four stroke cycle spark ignition mode.

4. An ICE as in any one of the preceding claims, further comprising:
at least one engine parameter sensor for measuring at least one engine operating parameter and for generating at least one signal in response thereto;
at least one sensor signal controller, capable of receiving and processing said at least one signal from said at least one engine parameter sensor;
said at least one sensor signal controller capable of controlling the flow rate of said actively powered fan.

5. An ICE as in any one of the preceding claims, wherein said exhaust passage is a poppet valve.

6. An ICE as in any one of the preceding claims, wherein said exhaust passage is a piston controlled port.

7. An ICE as in any one of the preceding claims, wherein said intake passage is a poppet valve.

8. An ICE as in any one of the preceding claims, further comprising:
an intake manifold throttle.

9. An ICE as in any one of the preceding claims, further comprising:
an exhaust manifold throttle.

10. An ICE as in any one of the preceding claims, wherein:
said actively powered exhaust fan is driven electrically.

11. An ICE as in any one of the preceding claims, wherein:
said actively powered exhaust fan is driven mechanically.
